(19) United States
(12) Patent Application Publication
(10) Pub. No.: US 2026/0368763 A1
(43) Pub. Date: Nov. 19, 2026

(54) SYSTEMS AND METHODS FOR SIGNAL-DRIVEN EXPLAINABLE DECISION ARCHITECTURES FOR CREATOR-MARKETING SYSTEMS

(71) Applicant: Amit Magen, Salit (IL)

(72) Inventor: Amit Magen, Salit (IL)

(21) Appl. No.: 19/678,176

(22) Filed: May 15, 2026

Related U.S. Application Data
(60) Provisional application No. 63/806,287, filed on May 15, 2025.

(51) Int. Cl. G06Q 30/0201; G06N 5/045

(52) U.S. Cl. CPC G06Q 30/02013; G06N 5/045; G06Q 30/020141

(57) ABSTRACT

A system and method for signal-driven explainable decision architectures for creator-marketing systems receives heterogeneous creator-marketing data inputs and normalizes them through an intake normalization layer. A transformation layer converts normalized data into Intent representation, Context representation, and Retrieval-Key attribute set. An evidence-weighted retrieval layer retrieves bounded Evidence Objects through non-optional technical gating operation. A signal layer, organized as decision guardrail system, computes intermediate Signal Objects through hierarchical Signal Dependency Graph, augmented by behavioral video analysis, bio-derived signal computation, profile health analysis, and trend intelligence sub-modules. A constraint engine and decision engine evaluate Signal Objects against hard and soft Constraint Objects to generate bounded operational decision states comprising pass, weak_match, review_required, and no_go. The no_go state is an operational blocking output preventing discovery, recommendation, negotiation, and workflow progression. An explainability output layer generates machine-readable Explainability Artifacts. An enforcement and routing layer controls downstream system behaviors based on generated decision states.

### CROSS-REFERENCE TO RELATED APPLICATIONS

This application claims priority to and the benefit of U.S. Provisional Patent Application No. 63/806,287, filed May 15, 2025, the entire contents of which are incorporated herein by reference in their entirety.

### FIELD OF THE INVENTION

The present invention relates generally to computer-implemented decision architectures and signal processing systems. More particularly, the invention relates to multi-modal signal computation, evidence-weighted intermediate signal generation, and constraint-governed decision-state evaluation in the field of creator-marketing intelligence platforms.

### BACKGROUND OF THE INVENTION

In the domain of creator-marketing intelligence, brands and marketing operators seek to identify, evaluate, and engage content creators whose behavioral characteristics, content attributes, and audience profiles are compatible with a given campaign's objectives, constraints, and risk tolerance. Existing systems that purport to address this need suffer from fundamental technical deficiencies that limit their utility and reliability as decision-grade computational architectures.

Prior art systems typically function as ranking or recommendation engines that apply simple scoring heuristics—such as follower count thresholds, keyword tag matching, or demographic overlap metrics—to surface a list of candidate creators. Such systems do not generate machine-interpretable decision states; they do not enforce hard operational constraints that block system actions; they do not produce structured explainability artifacts linked to underlying evidence; and they do not exercise downstream system control as a function of computed decision outputs.

A further deficiency of prior art systems is their failure to normalize heterogeneous, platform-specific creator and campaign data into a unified machine-readable schema before processing. Without such normalization, signal computation is inconsistent across platforms, and decision outputs cannot be reliably reproduced or audited.

Additionally, prior art systems do not differentiate between operational no-go conditions and recommendation outputs. A conventional ranking engine will always produce a ranked list regardless of whether any candidate satisfies a minimum viability threshold. The absence of an explicit no-go enforcement mechanism means that prior art systems can surface candidates that actively fail hard constraints, exposing downstream workflows to risk without operational safeguards.

Prior art systems also fail to incorporate multi-modal behavioral analysis of creator video content as a source of structured intermediate signals. Behavioral indicators, such as facial expression patterns, vocal tone characteristics, speech pacing, emotional intensity, gesture frequency, and authenticity indicators, carry meaningful information about a creator's content style and emotional resonance with audiences. No known prior art system converts such behavioral indicators into structured computational signals that feed into a constraint-aware decision engine.

Further, prior art systems do not model creator performance dynamics across time windows. Static point-in-time engagement snapshots do not capture trajectory, decay, or behavioral consistency over time. Existing systems likewise do not propagate confidence or uncertainty estimates through their scoring pipelines, providing no quantified measure of the reliability of their outputs. Decision outputs generated without confidence calibration cannot be audited, overridden, or conditioned on data quality thresholds, rendering them unsuitable for deployment in automated downstream control workflows.

There exists, therefore, an unmet need in the art for a computer-implemented decision architecture that addresses each of the foregoing deficiencies: one that normalizes heterogeneous platform-specific data before processing; enforces hard operational constraints with explicit blocking capability rather than always producing a ranked output; derives structured intermediate signals from multi-modal creator content including behavioral video analysis; models creator performance dynamics over time; calibrates decision outputs with quantified confidence and uncertainty measures; produces evidence-linked explainability artifacts as functional system components rather than display features; and exercises direct control over downstream system behaviors as a function of generated decision states.

### SUMMARY OF THE INVENTION

The present invention provides a computer-implemented decision architecture, referred to herein as the System, that transforms heterogeneous creator-marketing inputs into machine-readable representations, computes evidence-weighted intermediate signals through a hierarchical Signal Dependency Graph, generates bounded operational decision states through a constraint-aware decision engine, produces structured explainability artifacts, and controls downstream system behavior based on those decision outputs.

In a first aspect, the invention provides a computer-implemented system comprising: an intake normalization layer configured to receive and normalize heterogeneous creator-marketing data inputs into a unified machine-readable decision schema; a transformation layer configured to convert normalized inputs into structured intent representations, context representations, and retrieval-key attributes; an evidence-weighted retrieval layer configured to retrieve candidate creator and content records based on retrieval-key attributes and to evaluate associated evidence objects according to defined weighting criteria; a signal layer configured to compute intermediate signals from evidence objects through a hierarchical signal dependency graph; a decision engine configured to consume intermediate signals, confidence estimates, and system constraints to generate bounded operational decision states comprising at least pass, weak_match, review_required, and no_go states; an explainability output layer configured to generate structured explainability artifacts linked to underlying evidence; and an enforcement and routing layer configured to control downstream system behaviors based on generated decision states.

In a second aspect, the present invention provides methods corresponding to the operation of the foregoing system layers, as set forth in the method claims herein.

In a third aspect, in certain embodiments, the signal layer further comprises a behavioral and affective video analysis sub-module configured to extract behavioral indicators from creator video content using computer vision, voice/speech analysis, and natural language processing, and to convert those behavioral indicators into structured behavioral signals.

In a fourth aspect, in certain embodiments, decision outputs generated by the decision engine control an automated constraint-governed negotiation control state machine that executes a negotiation workflow between brand entities and creator entities within system-defined operational constraints.

In a fifth aspect, in certain embodiments, a data-awareness routing system governs pipeline execution state based on data sufficiency evaluation, routing the system to additional data retrieval, structured intake, manual review, or decision output suppression when evidence quality thresholds are not met.

In a sixth aspect, in certain embodiments, the bounded operational decision state generated by the decision engine is used as a control signal for downstream campaign-spend workflows, including budget allocation, campaign approval, negotiation initiation, offer generation, or contract generation, such that no_go or review_required states prevent, pause, or route such workflows based on pricing constraints, campaign budget caps, brand-safety rules, confidence thresholds, validation failures, or contradiction indicators. This downstream control behavior protects influencer-marketing budgets before campaign spend is approved, but is provided as a downstream technical embodiment of the bounded operational decision state and does not limit the decision-control architecture of the present invention.

These and other aspects, features, and advantages of the present invention will be apparent from the following detailed description, the accompanying figures, and the claims.

### BRIEF DESCRIPTION OF DRAWINGS

The following figures, which form part of the present specification, are included to illustrate certain embodiments of the invention.

FIG. 1 is a block diagram illustrating an end-to-end multi-layer decision architecture of a system for signal-driven explainable decision architectures for creator-marketing systems according to a preferred embodiment of the present invention.

FIG. 2 is a block diagram illustrating a hierarchical signal dependency graph, showing the derivation of composite compatibility signals from raw evidence inputs through intermediate behavioral signals and cross-signal validation.

FIG. 3 is a flow diagram illustrating an internal logic of the decision engine.

FIG. 4 is a state diagram illustrating a constraint-governed negotiation control state machine of certain embodiments.

FIG. 5 is a pipeline diagram illustrating a multi-modal behavioral video analysis sub-module of the signal layer.

FIG. 6 is an architecture diagram illustrating a transformation layer.

FIG. 7 is a block flow diagram illustrating an evidence-weighted retrieval layer.

FIG. 8 is an object structure diagram illustrating an explainability artifact produced by an explainability output layer.

FIG. 9 is a block flow diagram illustrating a bio-derived signal sub-module of the signal layer.

FIG. 10 is a block flow diagram illustrating a profile health analysis sub-module.

FIG. 11 is a block flow diagram illustrating a decision-grade trend intelligence sub-module.

FIG. 12 is a flow diagram illustrating a data-awareness routing system.

FIG. 13 is a block flow diagram illustrating compatibility scoring and signal integration flow.

### DETAILED DESCRIPTION OF THE INVENTION

The following detailed description sets forth specific embodiments of the invention with sufficient particularity to enable a person having ordinary skill in the art to make and use the invention without undue experimentation. The description is not intended to limit the scope of the claims, which are set forth separately below. Throughout this specification, the term “the system” refers to the computer-implemented decision architecture that is the subject of the present invention.

The system is a decision-grade, signal-driven, explainable system control architecture. It is not an analytics tool, a recommendation engine, a ranking system, or a marketing intelligence dashboard. Its bounded operational decision outputs —pass, weak_match, review_required, and no_go —are system control commands that directly govern pipeline execution state and downstream system behavior: they block discovery, suppress recommendations, gate negotiation initiation, and route workflows. The System does not advise human operators about which creators to select; it controls what the system does with each candidate creator as a function of structured signal-governed decision reasoning. The system receives heterogeneous creator-marketing inputs, computes structured intermediate signals through a guardrail-organized Signal Dependency Graph, evaluates those signals through a Constraint Engine and Decision Engine to produce bounded operational decision states, and directly controls downstream system behavior —including discovery gating, recommendation suppression, negotiation initiation blocking, and workflow routing —as a function of those decision states. The system's decision outputs are operational system control commands, not advisory outputs or ranked suggestions.

Artificial intelligence-derived analyses —including computer vision outputs, NLP outputs, and audio analysis outputs —function as inputs to signal computation within the Signal Layer. AI models are not the decision-makers in this architecture. Decision authority resides in the signal-governed Constraint Engine and Decision Engine, which evaluate structured Signal Objects against defined Constraint Objects and confidence thresholds to generate bounded operational decision states.

As used herein, the following terms shall have the meanings ascribed to them in this section. A “Brand Object” is a machine-readable data structure encoding brand identity attributes, stylistic parameters, values, and campaign-specific constraints associated with a brand entity. A “Campaign Object” is a machine-readable data structure encoding campaign objectives, key performance indicator (KPI) priorities, budget constraints, timing parameters, platform constraints, and risk tolerance parameters associated with a particular marketing campaign. A “Creator Object” is a machine-readable data structure encoding creator identity attributes, platform presence data, historical performance data, audience demographic attributes, pricing data, and content style parameters associated with a content creator entity.

An “Evidence Object” is a machine-readable data structure that encodes a discrete unit of evidence associated with a Creator Object or Campaign Object, including source provenance, recency timestamp, data completeness indicators, source reliability scores, and raw evidence payload. A “bounded Evidence Object” is an Evidence Object that has been designated bounded by the bounded evidence gating operation 750 of the evidence-weighted retrieval layer 300, said designation occurring upon the Evidence Object satisfying defined minimum-weighting thresholds across all applicable weighting criteria evaluated during the evidence weighting evaluation operation 730. The qualifier “bounded” denotes a technical gating property and is characterized by: (i) a defined source provenance attribute identifying the originating data source and source-reliability class assigned during provenance tagging by the intake normalization layer 100; (ii) satisfaction of an admissibility threshold corresponding to the aggregate Evidence Weight score being equal to or greater than the defined minimum-weight gate; (iii) an evidence-weight value computed as a function of relevance, recency, completeness, source reliability, signal quality, and contradiction indicator components; (iv) a bounded scope of use limited to consumption by the signal layer 400 and downstream layers and to representation in the evidence_references field of the Explainability Artifact; (v) a defined connection to one or more downstream Signal Objects through dependency-reference fields recorded in the Signal Dependency Graph 410; and (vi) exclusion from downstream processing of any Evidence Object whose aggregate Evidence Weight score falls below the defined minimum threshold, such Evidence Objects being technically excluded 745 by the bounded evidence gating operation 750 and not transmitted to the signal layer 400. A “Signal Object” is a machine-readable data structure that encodes a computed intermediate signal derived from one or more Evidence Objects, including signal identifier, signal value, confidence estimate, uncertainty value, and dependency references to the Evidence Objects or Signal Objects from which the signal was derived. A “Decision Object” is a machine-readable data structure that encodes a bounded operational decision state, including decision status, confidence score, uncertainty value, evidence references, reason codes, validation failure flags, and trade-off indicators.

A “Constraint Object” is a machine-readable data structure encoding a hard or soft operational constraint, including constraint type, constraint threshold, enforcement action, and priority level. A “Routing Object” is a machine-readable data structure encoding downstream system routing instructions generated as a function of a Decision Object. An “Explainability Artifact” is a structured, machine-readable output produced by the Explainability Output Layer that encodes the Decision Object, linked Evidence Objects, contributing Signal Objects, reason codes, uncertainty measures, and validation failure indicators, and that is suitable for storage, auditing, and downstream consumption.

The term “bounded operational decision state” refers to a discrete, machine-interpretable output generated by a decision engine, selected from a defined finite set of states: pass, weak_match, review_required, and no_go. These states are not advisory rankings; they are operational system outputs that directly govern downstream system behavior through the enforcement and routing layer.

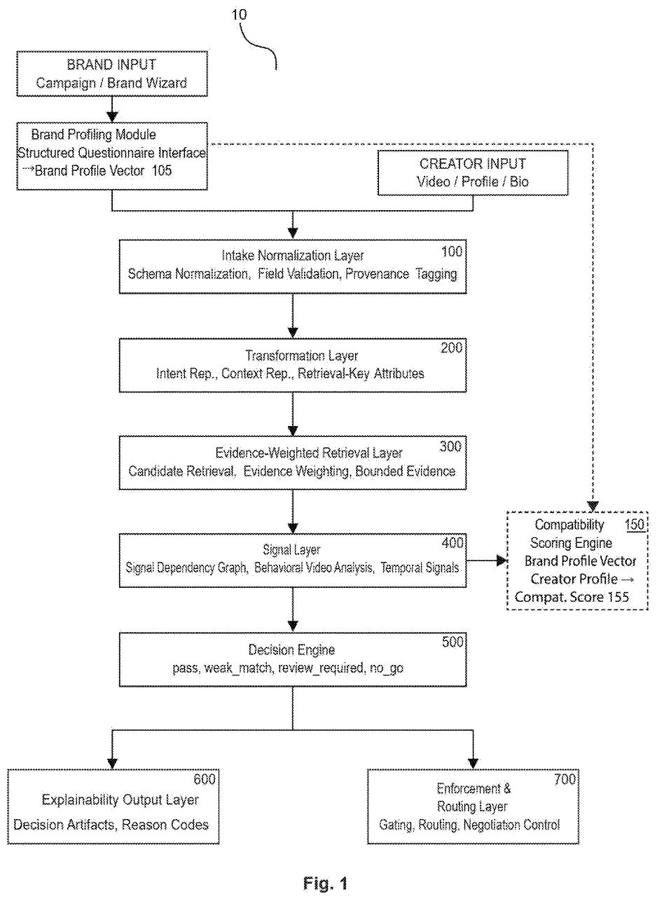

According to an exemplary embodiment of the present invention, a system 10 for signal-driven explainable decision architectures for creator-marketing systems is disclosed. Referring now to FIG. 1, the system 10 comprises an intake normalization layer 100 that constitutes the first computational stage of the decision control architecture. The intake normalization layer 100 is configured to receive raw inputs from a plurality of heterogeneous sources and to perform normalization, validation, and transformation operations sufficient to produce a unified machine-readable representation suitable for consumption by downstream system layers.

The heterogeneous input sources processed by the intake normalization layer 100 include, without limitation: brand wizard inputs comprising brand identity attributes, style parameters, and value declarations entered by a brand operator through a brand configuration interface; campaign wizard inputs comprising campaign objectives, KPI definitions, budget parameters, timing parameters, platform targeting parameters, and risk tolerance parameters entered by a campaign operator; creator profile records comprising platform-specific profile data retrieved from social media platform application programming interfaces (APIs) or entered by creator operators; social platform metadata comprising platform-specific engagement metrics, audience demographic data, and content distribution data; video transcripts and captions associated with creator-generated video content; creator biographical text comprising creator self-descriptions, category declarations, and partnership history; historical campaign performance data comprising prior campaign outcomes, engagement rate records, and audience response metrics; pricing intelligence data comprising creator-declared rate cards, market rate benchmarks, and negotiation history records; profile screenshot captures comprising visual representations of creator profile pages submitted for analysis; and uploaded campaign reports comprising structured or unstructured documents encoding prior campaign performance data.

Upon receipt of raw inputs, the intake normalization layer 100 performs a plurality of technical operations. A schema normalization operation maps platform-specific field identifiers to a unified field ontology defined by the system's decision schema. A field validation operation evaluates each input field against defined type constraints, value range constraints, and format constraints, and generates validation failure flags for fields that fail validation. A missingness handling operation identifies absent required fields, computes data completeness scores, and initiates data completeness flags that are propagated to downstream layers including the data-awareness routing system. A provenance tagging operation annotates each normalized data element with metadata encoding the source identifier, source reliability class, and ingestion timestamp. A temporal normalization operation converts platform-specific timestamp formats to a unified temporal representation and computes recency scores for time-stamped data elements. A platform normalization operation maps platform-specific engagement metric definitions to a unified engagement metric schema, enabling cross-platform signal comparison.

The output of the intake normalization layer 100 is a set of normalized data objects comprising a Brand Object, a Campaign Object, and one or more Creator Objects, each conforming to the system's unified machine-readable decision schema, annotated with provenance metadata, validation flags, completeness scores, and recency scores. These normalized objects constitute the input to the transformation layer 200.

In certain embodiments, the intake normalization layer 100 further comprises a Brand Profiling Module 105 configured to receive brand identity inputs from a brand operator through a structured questionnaire interface and to produce a Brand Profile Vector as part of the Brand Object transmitted to the transformation layer 200. The Brand Profiling Module 105 presents the brand operator with a guided questionnaire comprising a plurality of attribute scales encoding brand identity dimensions, including without limitation: stylistic scales encoding the brand's visual and tonal character such as modern-versus-traditional, playful-versus-professional, and warm-versus-edgy; emotional tone scales encoding the desired emotional register of brand-associated content; audience attribute scales encoding target audience demographic and psychographic parameters; and campaign objective parameters encoding the brand's defined goals for the relevant marketing campaign.

The Brand Profiling Module 105 maps each questionnaire response to a corresponding numerical value through a defined attribute-to-value mapping function, producing a Brand Profile Vector comprising a multi-dimensional numerical representation of the brand's style attributes, emotional tone parameters, and campaign objectives in a unified machine-readable feature space. The Brand Profile Vector is encoded within the Brand Object and transmitted to the transformation layer 200, where it contributes to the derivation of the Intent representation 210 and the Context representation 220. The Brand Profile Vector is additionally transmitted to the signal layer 400 where it parameterizes Brand Alignment signal computation, enabling the signal layer 400 to compute the degree of stylistic and tonal compatibility between creator content characteristics and the brand's defined identity.

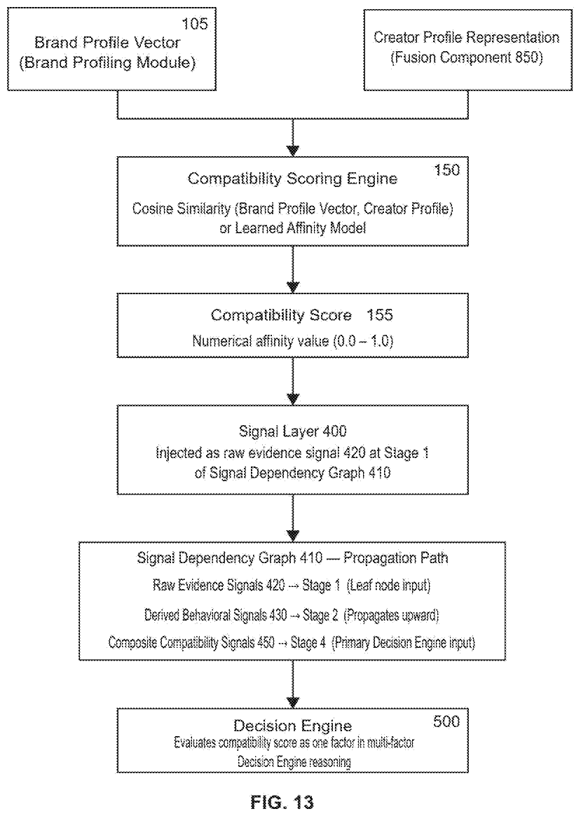

Referring to FIG. 13, in certain embodiments the system 10 further comprises a compatibility scoring engine 150 configured to receive the Brand Profile Vector produced by the Brand Profiling Module 105 and the unified Creator Profile representation produced by a behavioral and affective video analysis sub-module 800, and to compute a compatibility score quantifying the degree of alignment between the brand's defined style attributes and emotional tone parameters and the creator's content characteristics encoded in the unified Creator Profile representation. The compatibility scoring engine 150 computes the compatibility score 155 using at least one of: a cosine similarity function applied to the Brand Profile Vector and the Creator Profile representation as vectors in a common feature space; or a learned affinity model trained to predict compatibility between brand and creator representations. The compatibility score 155 produced by the compatibility scoring engine 150 constitutes a numerical affinity value encoding the degree to which the creator's authentic content style and emotional tone align with the brand's defined values and campaign objectives.

The compatibility score 155 produced by the compatibility scoring engine 150 is transmitted to the signal layer 400 as a raw evidence signal 420, where it is injected into the Signal Dependency Graph 410 at the first stage and propagates upward through derived behavioral signals 430, cross-signal validation signals 440, and composite compatibility signals 450 to the decision engine 500. The compatibility scoring engine 150 thereby provides the primary quantitative measure of brand-creator alignment as a structured Signal Object input to the decision architecture, enabling the decision engine 500 to evaluate compatibility as one factor within the multi-factor Decision Graph reasoning process rather than as a standalone scoring output. In certain embodiments, the compatibility scoring engine 150 additionally generates attribute contribution indicators identifying which dimensions of the Brand Profile Vector and Creator Profile representation contributed most significantly to the computed compatibility score 155, which are encoded in the trade_off_indicators field of the Explainability Artifact generated by the explainability output layer 600.

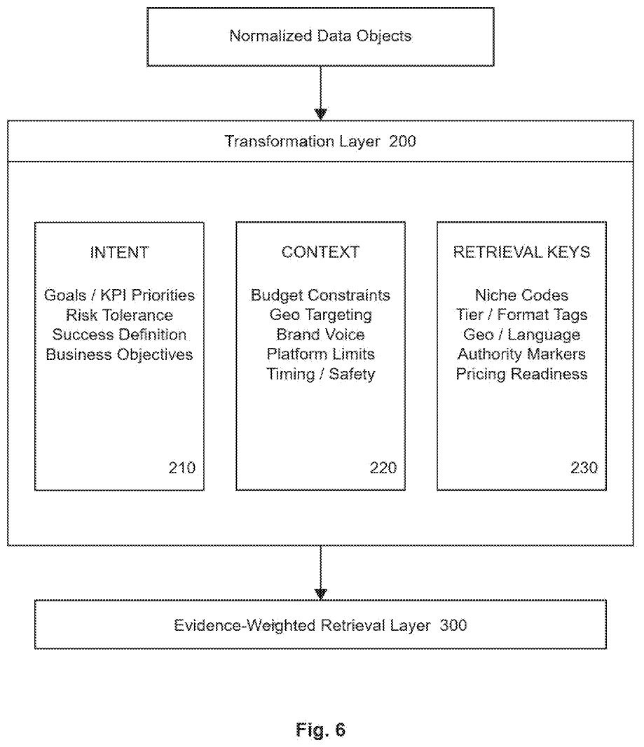

Referring to FIG. 6, the transformation layer 200 constitutes the second computational stage of the system 10 and is a core differentiating element of the present invention. The transformation layer 200 is configured to receive normalized data objects from the intake normalization layer 100 and to perform structured transformations that convert those objects into three distinct machine-readable representations: an Intent representation 210, a Context representation 220, and a Retrieval-Key attribute set 230. These three representations constitute the structured computational foundation that governs all downstream retrieval, signal computation, constraint evaluation, and decision generation operations within the system 10.

The Intent representation 210 encodes the campaign's computational decision objectives. The transformation layer 200 derives the Intent representation 210 from the Campaign Object received from the intake normalization layer 100 by extracting and mapping: business objective codes derived from campaign KPI declarations; priority weighting vectors encoding the relative priority of each declared KPI metric as a normalized numerical weight, such that signal dimensions corresponding to higher-priority KPIs receive proportionally greater weight in the soft constraint scoring operation 520 of the decision engine 500; risk tolerance parameters encoding acceptable risk thresholds for downstream constraint evaluation within the constraint engine; and success definition parameters encoding minimum acceptable performance thresholds for decision state generation. The Intent representation 210 is transmitted to the decision engine 500 where it parameterizes the soft constraint weighting scheme applied during soft constraint scoring operation 520.

The Context representation 220 encodes operational constraints governing the decision process. The transformation layer 200 derives the Context representation 220 from both the Brand Object and Campaign Object received from the intake normalization layer 100 by extracting and mapping: audience attribute vectors encoding target audience demographic parameters; geographic targeting codes encoding campaign geographic scope; brand voice parameters encoding stylistic and tonal constraints derived from Brand Object attributes; campaign budget parameters encoding monetary constraints; timing constraint parameters encoding campaign duration, start date, and deadline constraints; platform constraint parameters encoding permissible creator platform types; influencer tier constraint parameters encoding permissible creator size categories; and brand safety parameters encoding content restriction rules derived from Campaign Object declarations. The Context representation 220 is transmitted to a decision engine 500 where it populates the Constraint Objects evaluated during hard constraint evaluation 510 and soft constraint scoring 520.

The Retrieval-Key attribute set 230 comprises machine-generated attributes derived through deterministic mapping functions applied to corresponding fields of the Intent representation 210 and Context representation 220. The Retrieval-Key attribute set 230 is not manually specified by operators; each attribute is generated through a defined deterministic mapping function, ensuring reproducibility and auditability of the retrieval stage. Retrieval-Key attributes comprise: niche category codes; subcategory codes; authority marker indicators; influencer tier codes; content format codes; geographic tags; audience characteristic codes; platform availability flags; brand safety indicator codes; language codes; and pricing readiness indicators. The Retrieval-Key attribute set 230 is transmitted to the evidence-weighted retrieval layer 300 where it parameterizes the candidate retrieval query executed against the creator data store.

The output of the transformation layer 200 comprises the Intent representation 210, the Context representation 220, and the Retrieval-Key attribute set 230, which are collectively transmitted to the evidence-weighted retrieval layer 300 and, in the case of the Intent representation 210 and Context representation 220, also transmitted to the decision engine 500 to parameterize constraint evaluation and soft constraint weighting.

The transformation layer 200 thereby converts raw heterogeneous inputs into structured computational representations required for consistent and reproducible decision processing in downstream layers. The output of the transformation layer 200 including the intent representation 210, the context representation 220, and the retrieval-key attribute set 230, which are collectively transmitted to an evidence-weighted retrieval layer 300.

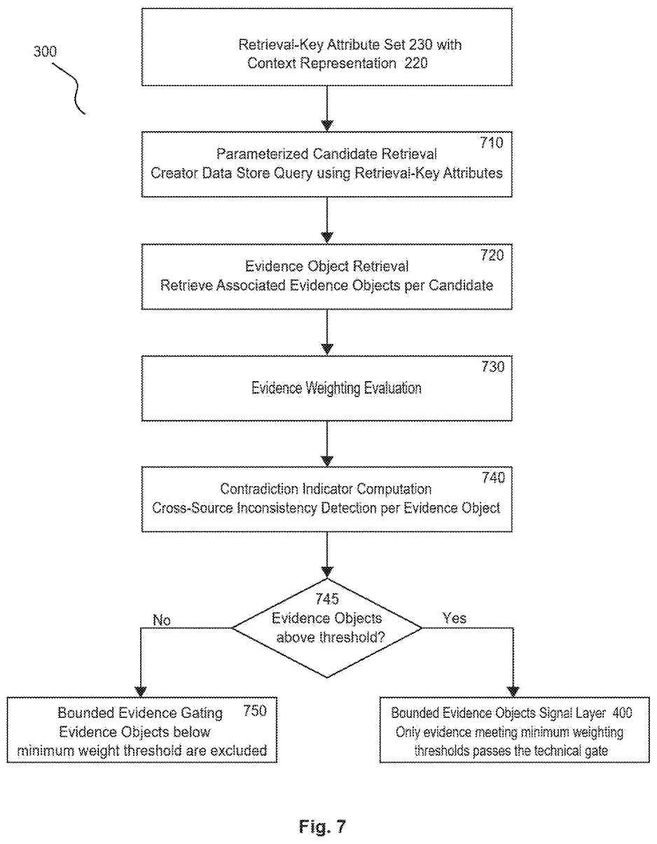

Referring to FIG. 7, the evidence-weighted retrieval layer 300 constitutes the third computational stage of the system 10. The evidence-weighted retrieval layer 300 is configured to receive the Retrieval-Key attribute set 230 and the Context representation 220 from the transformation layer 200 and to perform a multi-stage structured retrieval and gating pipeline that produces bounded Evidence Objects as its sole output for transmission to the signal layer 400.

The term “bounded” as used in this context denotes a technical gating property, not a filtering preference. An Evidence Object is designated as bounded only upon satisfying defined minimum weighting thresholds across all applicable weighting criteria evaluated during the evidence weighting operation 730 described below. The bounded evidence gating operation 750 is a non-optional system enforcement mechanism that cannot be overridden by operator configuration. Its purpose is to ensure that the Signal Dependency Graph 410 of the signal layer 400 operates exclusively on evidence of sufficient quality to support reliable signal computation, and that Decision Objects generated by the decision engine 500 are based only on evidence that has passed an objective minimum sufficiency standard.

The evidence-weighted retrieval layer 300 proceeds through the following sequential stages. In a first stage, a parameterized candidate retrieval operation 710 receives the Retrieval-Key attribute set 230 from the transformation layer 200 and executes a structured parameterized query against the creator data store using the Retrieval-Key attributes as retrieval parameters, returning a candidate set of Creator Objects whose stored attributes match the parameterized criteria.

In a second stage, an evidence object retrieval operation 720 receives the candidate set of Creator Objects from the parameterized candidate retrieval operation 710 and, for each candidate Creator Object in the candidate set, retrieves all associated Evidence Objects from the evidence data store. The retrieved Evidence Objects constitute the raw evidence set for each candidate creator.

In a third stage, an evidence weighting evaluation operation 730 receives each retrieved Evidence Object from the evidence object retrieval operation 720 and evaluates it according to a plurality of weighting criteria, comprising: relevance score, computed as the degree of relevance of the evidence payload to the decision context encoded in the Context representation 220 received from the transformation layer 200; recency score, computed from the recency metadata attached to the Evidence Object by the intake normalization layer 100 during provenance tagging; data completeness score, computed from the completeness flags attached to the Evidence Object by the missingness handling operation of the intake normalization layer 100; source reliability score, computed from the provenance metadata indicating the reliability class of the evidence source assigned during provenance tagging; signal quality estimate, computed as an assessment of the discriminative value of the evidence payload for downstream signal computation within the signal layer 400; and contradiction indicator, computed by detecting inconsistencies between the Evidence Object and other Evidence Objects associated with the same Creator Object retrieved in the evidence object retrieval operation 720. Each weighting criterion contributes a weighted component to an aggregate Evidence Weight score for the Evidence Object.

In a fourth stage, a contradiction indicator computation operation 740 receives the Evidence Objects and their associated Evidence Weight scores from the evidence weighting evaluation operation 730 and performs cross-source inconsistency detection by comparing evidence payloads across independently sourced Evidence Objects associated with the same Creator Object. Detected inconsistencies generate a contradiction severity score that is attached to each affected Evidence Object as a metadata attribute. This contradiction severity score is subsequently propagated as a contradiction indicator into the Signal Dependency Graph 410 where it contributes to cross-signal validation signals 440 at Stage 3 of the graph, and is further consumed by the contradiction detection operation 530 of the decision engine 500.

In a fifth stage, the bounded evidence gating operation 750 receives the Evidence Objects with their aggregate Evidence Weight scores from the contradiction indicator computation operation 740 and applies the technical gate: Evidence Objects whose aggregate Evidence Weight score falls below a defined minimum threshold are excluded 745 from all downstream processing and are not passed to the signal layer 400. Only Evidence Objects whose aggregate Evidence Weight score meets or exceeds the minimum threshold across all applicable weighting criteria are designated as bounded Evidence Objects. The output of the evidence-weighted retrieval layer 300 is a candidate set comprising, for each candidate creator, a Creator Object paired with a set of bounded Evidence Objects. This candidate set is transmitted to the signal layer 400 for signal computation.

The signal layer 400 constitutes the fourth and central computational stage of the system 10. The signal layer 400 functions as a decision guardrail system: it does not produce ranked scores, recommendation lists, or decision states. It computes structured intermediate Signal Objects—discrete computational objects carrying signal values, confidence estimates, uncertainty values, and dependency references—that serve as inputs to the constraint engine and decision engine 500. Signal computation and decision evaluation are architecturally separate stages: the signal layer 400 completes all signal computation and confidence calibration before any evaluation against Constraint Objects or confidence thresholds occurs. Decision states are generated exclusively by the constraint engine and decision engine 500, only after receiving Signal Objects from the signal layer 400 and evaluating them against hard Constraint Objects, soft Constraint Objects, contradiction thresholds, and confidence thresholds. No signal value alone determines a decision state.

Signal Objects are not scores. They are structured intermediate computational objects that actively govern decision eligibility, confidence calibration, and routing through three guardrail categories. Opportunity signals—including Engagement Strength, Audience Match, Content Relevance, Brand Alignment, Authority, Niche Depth, and Pricing Suitability signals—encode positive eligibility indicators. Risk signals—including Risk signals, Validation signals, and Multi-Niche Flag signals—function as decision eligibility gatekeepers that may directly trigger hard Constraint Object evaluation in the constraint engine upon propagation to composite compatibility signals 450. Data completeness signals—including Platform Availability, Data Completeness, and Niche Confidence signals—govern routing outcomes and activate the data-awareness routing system 1200 when evidence coverage is insufficient. No Signal Object alone determines a decision state; decisions emerge only after Signal Objects are evaluated by the constraint engine and decision engine 500 against Constraint Objects, contradiction thresholds, and confidence thresholds.

The signal layer 400 is configured to receive bounded Evidence Objects from the evidence-weighted retrieval layer 300 and to compute intermediate Signal Objects corresponding to a plurality of signal families. Each signal family encodes a distinct dimension of creator-campaign compatibility and performs a defined guardrail function within the decision control architecture. Signal families computed by the signal layer 400 include, without limitation:
Engagement Strength signals, encoding the relative magnitude and consistency of creator audience engagement across platform-specific metrics, normalized to a unified engagement scale using the platform normalization schema produced by the intake normalization layer 100;
Audience Match signals, encoding the degree of alignment between creator audience demographic attributes encoded in Creator Objects and campaign target audience parameters encoded in the Context representation 220 received from the transformation layer 200;
Content Relevance signals, encoding the degree of topical and thematic alignment between creator content attributes and campaign content requirements derived from the Campaign Object;
Brand Alignment signals, encoding the degree of stylistic and tonal compatibility between creator content behavioral characteristics and Brand Object parameters;
Authority signals, encoding the degree of subject matter authority demonstrated by the creator within the relevant niche category, informed by bio-derived authority marker signals 942 produced by the bio-derived signal sub-module described below;
Niche Depth signals, encoding the degree of content specialization of the creator within the relevant niche category, informed by bio-derived niche indicator signals 941;
Pricing Suitability signals, encoding the compatibility of creator rate parameters with campaign budget constraints encoded in the Context representation 220, informed by bio-derived pricing readiness signals 946;
Saturation and Trend Opportunity signals, encoding the degree of niche market saturation and available trend momentum for the creator's content category, informed by trend-derived signals from the trend intelligence sub-module;
Risk signals, encoding identified risk factors associated with the creator, including brand safety risk, content consistency risk, and engagement authenticity risk, informed by bio-derived risk indicator signals 945 and profile-derived risk flag signals 1065; Risk signals that exceed defined thresholds contribute to hard Constraint Object evaluation in the constraint engine;
Validation signals, encoding cross-source evidence consistency scores and data integrity assessments derived from the contradiction indicators attached to Evidence Objects by the contradiction indicator computation operation 740 of the evidence-weighted retrieval layer 300;
Platform Availability signals, encoding the match between creator platform presence and campaign platform targeting parameters encoded in the Context representation 220;
Data Completeness signals, encoding the degree of evidence completeness available for the creator across required decision dimensions, derived from the data completeness flags produced by the intake normalization layer 100 and the signal completeness assessment of the data-awareness routing system; Low data completeness signal values activate the data-awareness routing system;
Niche Confidence signals, encoding the reliability of niche categorization for the creator based on available evidence, informed by bio-derived niche indicator signals 941; and
Multi-Niche Flag signals, encoding the detection of creator content spanning multiple niche categories in a manner that may affect targeting precision, derived from analysis of niche indicator signals 941 and Content Relevance signals.

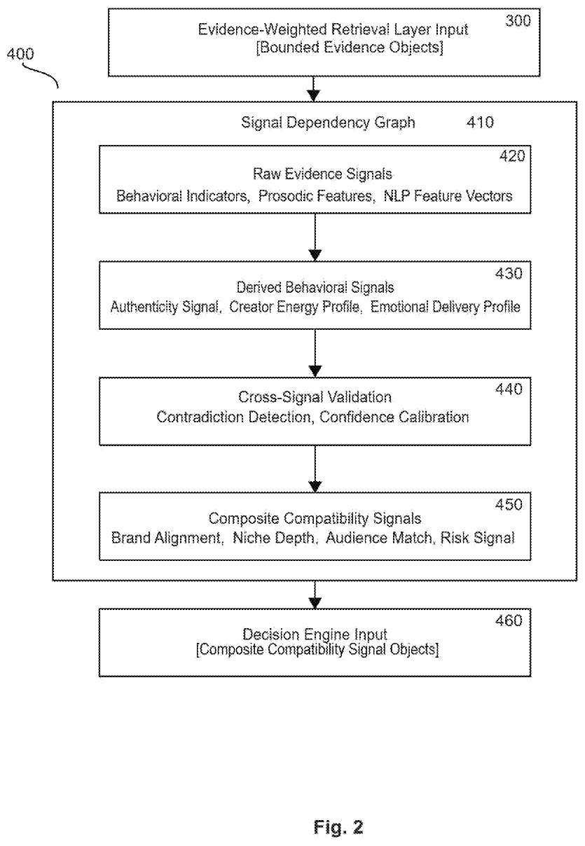

Referring to FIG. 2, the signal layer 400 organizes signal computation within a Signal Dependency Graph 410. The Signal Dependency Graph 410 is a directed acyclic graph in which nodes represent Signal Objects and directed edges represent computational dependency relationships between signals. Higher-order Signal Objects are derived from lower-level Signal Objects or from bounded Evidence Objects through defined computational transformation functions. The Signal Dependency Graph 410 comprises the following hierarchical computation stages.

At a first stage, raw evidence signals 420 are computed directly from bounded Evidence Objects received from the evidence-weighted retrieval layer 300. Raw evidence signals 420 represent the minimal computational transformation of bounded evidence data and serve as the leaf nodes of the Signal Dependency Graph 410. Bio-Derived Signal Objects 940 produced by the bio-derived signal sub-module and Profile-Derived Signal Objects 1060 produced by a profile health analysis sub-module 1000 are also injected into the Signal Dependency Graph 410 at this first stage as raw evidence signals 420.

At a second stage, derived behavioral signals 430 are computed from raw evidence signals 420 through defined transformation functions. Derived behavioral signals 430 encode higher-level constructs derived from raw behavioral indicators, including the authenticity signal, creator energy profile signal, and emotional delivery profile signal produced by the behavioral and affective video analysis sub-module 800 and injected at this stage, as further described below. Trend-derived Signal Objects produced by a trend intelligence sub-module 1100 and approved through the trend decision eligibility threshold are also injected at this stage.

At a third stage, cross-signal validation signals 440 are computed from combinations of derived behavioral signals 430 and other Signal Objects using contradiction detection functions and confidence calibration functions. Cross-signal validation signals 440 encode the degree of consistency or inconsistency among signals derived from different evidence sources, and carry confidence adjustment factors that modulate the confidence estimates of dependent signals. The contradiction severity scores attached to Evidence Objects by the contradiction indicator computation operation 740 of the evidence-weighted retrieval layer 300 contribute to the computation of cross-signal validation signals 440 at this stage. Cross-signal validation signals 440 are consumed by the contradiction detection operation 530 of the decision engine 500.

At a fourth stage, composite compatibility signals 450 are computed from cross-signal validation signals 440 and other derived signals through weighted aggregation and learned compatibility functions. Composite compatibility signals 450 constitute the primary inputs to the decision engine 500 and include Brand Alignment signals, Audience Match signals, and Engagement Strength signals at their highest computed levels of abstraction. Composite compatibility signals 450, together with their associated calibrated confidence estimates and uncertainty values, are transmitted from the signal layer 400 to the decision engine 500.

Each Signal Object produced by the Signal Dependency Graph 410 comprises: a signal identifier; a signal value encoded on a defined numerical scale; a confidence estimate reflecting the reliability of the signal value; an uncertainty value reflecting the range of plausible signal values given available evidence; and dependency references identifying the Evidence Objects or Signal Objects from which the signal was derived. The dependency references encoded in Signal Objects enable the explainability output layer 600 to construct evidence-linked explainability chains tracing each Decision Object back through Signal Objects to the underlying bounded Evidence Objects from which those Signal Objects were derived.

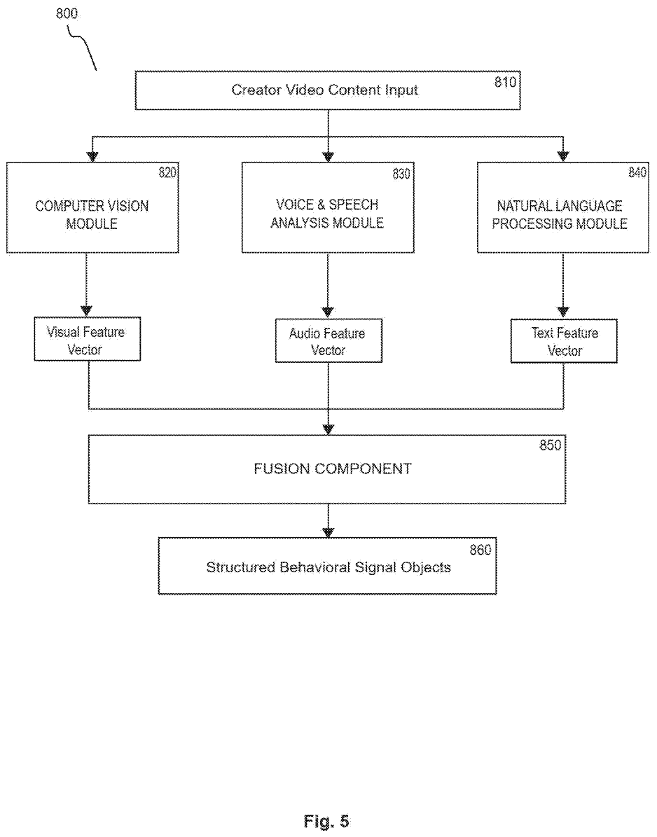

Referring to FIG. 5, in certain embodiments the signal layer 400 further comprises a behavioral and affective video analysis sub-module 800 configured to perform multi-modal computational analysis of creator video content and to extract structured behavioral indicators therefrom, converting those indicators into structured behavioral Signal Objects 860 that are injected into the Signal Dependency Graph 410.

The input to the behavioral and affective video analysis sub-module 800 is creator video content 810. The creator video content 810 is received from the creator operator through the creator content ingestion step described in connection with the processing workflow herein, either by direct upload of a video file to the system 10 or by submission of a platform-specific content link from which the system 10 retrieves the corresponding video asset. The creator video content 810 is stored by the system 10 only upon recording of a valid time-stamped digital consent record as described in connection with the consent interface. Upon verification of consent, the creator video content 810 is made available to the behavioral and affective video analysis sub-module 800 for multi-modal processing. The creator video content 810 constitutes the sole raw media input to the sub-module 800; all parallel processing modules —a computer vision module 820, a voice and speech analysis module 830, and a natural language processing module 840 —receive creator video content 810 as their common input source and extract their respective feature vectors therefrom independently and in parallel.

The behavioral and affective video analysis sub-module 800 comprises the computer vision module 820, the voice and speech analysis module 830, the natural language processing module 840, and a fusion component 850.

The computer vision module 820 is configured to receive creator video content 810 and to process individual video frames to extract visual behavioral indicators. The computer vision module 820 performs: facial expression detection, comprising the computational identification and classification of facial muscle movement patterns associated with emotional states; body gesture analysis, comprising the detection and classification of body movement patterns, hand gesture frequency, and postural indicators; scene and context recognition, comprising the identification of scene type, background objects, setting context, and environmental attributes; and color palette and lighting analysis, comprising the extraction of dominant color attributes and lighting condition parameters. The outputs of the computer vision module 820 comprise a visual feature vector encoding the extracted visual behavioral indicators. The visual feature vector is transmitted from the computer vision module 820 to the fusion component 850.

The voice and speech analysis module 830 is configured to process the audio track of creator video content 810 to extract prosodic and emotional behavioral indicators. The voice and speech analysis module 830 performs: pitch extraction, comprising the measurement of fundamental frequency contours across the audio signal; prosody analysis, comprising the characterization of speech rhythm, stress patterns, and intonation; loudness measurement, comprising the quantification of amplitude envelope parameters; speech pacing measurement, comprising the calculation of speech rate in phonemes or words per unit time; and emotional tone classification, comprising the assignment of emotional state labels and associated confidence scores based on prosodic features. The outputs of the voice and speech analysis module 830 comprise an audio feature vector encoding the extracted prosodic and emotional behavioral indicators. The audio feature vector is transmitted from the voice and speech analysis module 830 to the fusion component 850.

The natural language processing module 840 is configured to process the textual content associated with creator video content 810, including transcribed speech, on-screen caption text, comments, and associated hashtag metadata. The natural language processing module 840 performs: speech-to-text conversion, comprising the automated transcription of spoken audio content to text; sentiment analysis, comprising the computational determination of sentiment polarity and intensity for textual content; keyword and topic extraction, comprising the identification of salient semantic concepts, named entities, and thematic categories within the textual content; and contextual classification, comprising the assignment of content domain labels, audience appropriateness indicators, and brand safety flags. The outputs of the natural language processing module 840 comprise a text feature vector encoding the extracted semantic and sentiment indicators. The text feature vector is transmitted from the natural language processing module 840 to the fusion component 850.

The fusion component 850 is configured to receive the visual feature vector from the computer vision module 820, the audio feature vector from the voice and speech analysis module 830, and the text feature vector from the natural language processing module 840, and to combine those three vectors into a unified Creator Profile representation through a fusion operation comprising at least one of: vector concatenation, weighted vector aggregation, or a learned embedding transformation. The unified Creator Profile representation produced by the fusion component 850 encodes the creator's content style, behavioral characteristics, emotional resonance patterns, and thematic attributes in a common multi-dimensional representation suitable for signal computation.

The behavioral and affective video analysis sub-module 800 converts the unified Creator Profile representation received from the fusion component 850 into structured behavioral Signal Objects 860 comprising:
a creator energy profile signal, encoding the overall energy level and dynamism of the creator's content delivery;
an emotional delivery profile signal, encoding the characteristic emotional states conveyed through the creator's combined visual, vocal, and verbal behaviors; an authenticity signal, encoding the degree of behavioral consistency and naturalness detected across modalities;
a persuasion style indicator signal, encoding the characteristic persuasive communication style of the creator; and
a brand personality compatibility signal, encoding the computed alignment between the creator's behavioral characteristics and the brand personality parameters encoded in the Brand Object.

The structured behavioral Signal Objects 860 produced by the behavioral and affective video analysis sub-module 800 are injected into the Signal Dependency Graph 410 as derived behavioral signals 430 at Stage 2 of the graph and propagate upward through the graph to influence composite compatibility signals 450 at Stage 4, and ultimately constitute inputs to the decision engine 500.

In certain embodiments, prior to performing any analysis of creator video content, the system 10 presents a consent interface to the creator operator that specifies the nature of the analysis to be performed and the purposes for which the resulting data will be used. The system 10 records a time-stamped digital consent record upon the creator operator's affirmative acceptance. Processing of creator video content proceeds only upon recording of a valid consent record for the relevant content. If consent is not recorded, the system 10 halts processing of the relevant content and generates a data availability flag indicating consent absence, which is transmitted to a data-awareness routing system 1200 as a trigger condition.

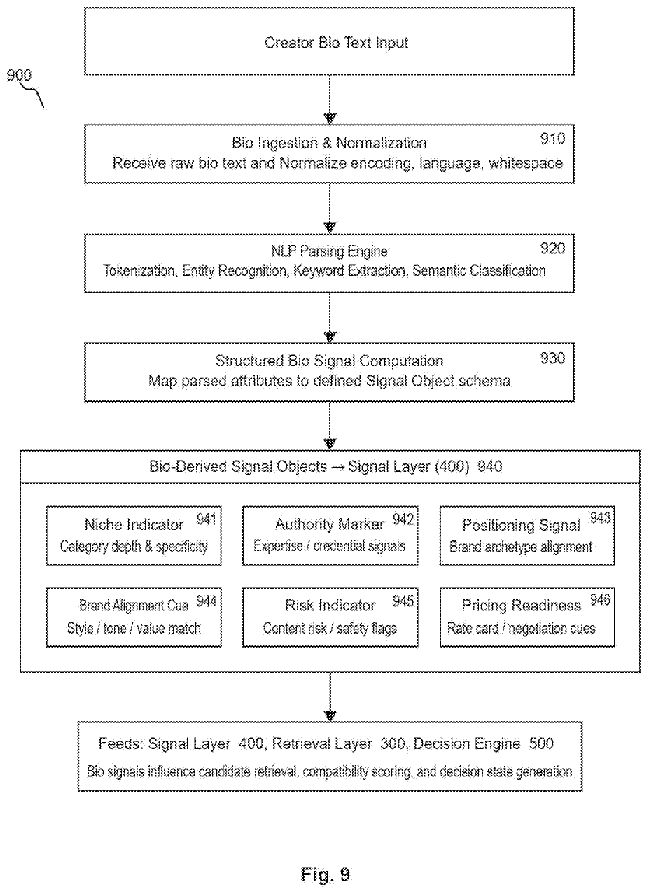

Referring to FIG. 9, in certain embodiments the signal layer 400 further comprises a bio-derived signal sub-module 900 configured to extract structured Signal Objects from creator biographical text and to inject those Signal Objects into the Signal Dependency Graph 410. Creator biographical text—including self-descriptions, niche declarations, expertise claims, partnership history references, and associated metadata—constitutes an independent evidence source encoding creator positioning, authority, and brand alignment characteristics not captured by engagement metrics or video content analysis.

The input to the bio-derived signal sub-module 900 is creator biographical text retrieved from the creator data store as part of the bounded Evidence Objects transmitted by the evidence-weighted retrieval layer 300. Upon receipt, a bio ingestion and normalization operation 910 normalizes the raw bio text by standardizing text encoding, removing extraneous formatting, normalizing language representation, and standardizing whitespace, producing normalized bio text suitable for natural language processing. The normalized bio text is transmitted from the bio ingestion and normalization operation 910 to the NLP parsing engine 920.

The NLP parsing engine 920 receives the normalized bio text from the bio ingestion and normalization operation 910 and applies the following natural language processing operations: tokenization, comprising the segmentation of the normalized bio text into discrete lexical units; named entity recognition, comprising the computational identification and classification of named entities including persons, organizations, locations, and domain-specific terms; keyword extraction, comprising the identification of salient keywords and keyphrases indicative of niche category, expertise domain, and content style; and semantic classification, comprising the assignment of semantic category labels to identified concepts based on a predefined semantic taxonomy relevant to creator-marketing compatibility. The outputs of the NLP parsing engine 920 comprise a set of parsed bio attributes encoding identified entities, topics, semantic categories, and extracted keywords. The parsed bio attributes are transmitted from the NLP parsing engine 920 to the structured bio signal computation operation 930.

The structured bio signal computation operation 930 receives the parsed bio attributes from the NLP parsing engine 920 and maps those attributes to defined Signal Object schema fields, thereby producing the following Bio-Derived Signal Objects 940:
a niche indicator signal 941, encoding the degree of content category depth and specificity demonstrated by the creator's declared niche, derived from the specificity and consistency of niche category labels identified by the NLP parsing engine 920; the niche indicator signal 941 is transmitted both to the Signal Dependency Graph 410 as a raw evidence signal 420 and to the transformation layer 200 where it augments the Retrieval-Key attribute set 230 to influence candidate retrieval parameterization in the evidence-weighted retrieval layer 300;
an authority marker signal 942, encoding the degree of subject matter expertise or credentialed authority indicated by the bio text, derived from detected expertise claims, credential indicators, and professional affiliation references identified by the NLP parsing engine 920; the authority marker signal 942 is transmitted both to the Signal Dependency Graph 410 as a raw evidence signal 420 and to the transformation layer 200 where it augments the Retrieval-Key attribute set 230;
a positioning signal 943, encoding the creator's brand archetype alignment derived from detected brand personality cues, tone indicators, and value statements extracted by the NLP parsing engine 920, transmitted to the Signal Dependency Graph 410 as a raw evidence signal 420;
a brand alignment cue signal 944, encoding style, tone, and value match indicators derived from bio text attributes compared against Brand Object parameters, transmitted to the Signal Dependency Graph 410 as a raw evidence signal 420;
a risk indicator signal 945, encoding content risk and brand safety flags derived from detected risk indicators in the bio text, transmitted to the Signal Dependency Graph 410 as a raw evidence signal 420 and additionally contributing to the Risk Signal family within the signal layer 400, from which it may influence hard Constraint Object evaluation within the constraint engine upon propagation to composite compatibility signals 450; and
a pricing readiness signal 946, encoding inferred pricing tier and negotiation readiness derived from detected rate card references, partnership history indicators, and pricing-related language in the bio text, transmitted to the Signal Dependency Graph 410 as a raw evidence signal 420.

All Bio-Derived Signal Objects 940 produced by the structured bio signal computation operation 930 are injected into the Signal Dependency Graph 410 as raw evidence signals 420 at Stage 1 of the graph and propagate upward through Stages 2, 3, and 4 to influence derived behavioral signals 430, cross-signal validation signals 440, and composite compatibility signals 450, which are ultimately transmitted to the decision engine 500.

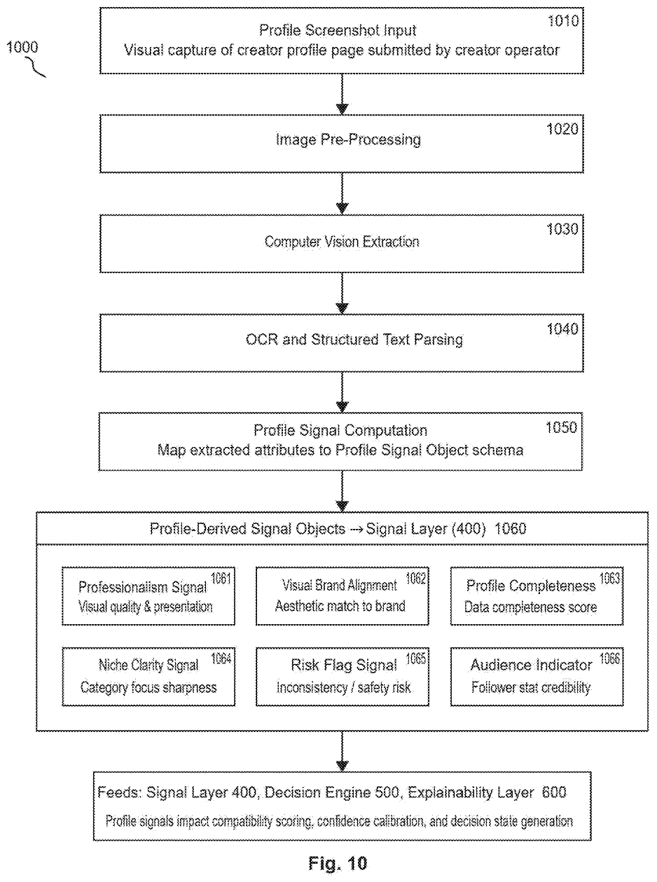

Referring to FIG. 10, in certain embodiments the signal layer 400 further comprises a profile health analysis sub-module 1000 configured to extract structured Signal Objects from profile screenshot captures and to inject those Signal Objects into the Signal Dependency Graph 410. A profile screenshot capture 1010 is a visual representation of a creator's social media profile page, submitted by the creator operator through the creator operator portal interface or retrieved automatically by the system 10 from a platform-specific content link. Profile screenshot captures 1010 encode visual and textual attributes of a creator's public profile presentation not directly accessible through platform API responses.

The input to the profile health analysis sub-module 1000 is a profile screenshot capture 1010 retrieved from the creator data store as part of the bounded Evidence Objects transmitted by the evidence-weighted retrieval layer 300. Upon receipt, an image pre-processing operation 1020 receives the profile screenshot capture 1010 and performs the following operations: decoding the image from its storage format; resizing the image to a normalized resolution suitable for computer vision processing; normalizing pixel values across a defined range; and performing region segmentation to identify distinct functional regions of the profile layout, including the profile image region, handle and bio text region, follower statistics region, post grid region, and highlight or story reel region. The pre-processed image with identified segmented regions is transmitted from the image pre-processing operation 1020 to the computer vision extraction operation 1030.

The computer vision extraction operation 1030 receives the pre-processed segmented image from the image pre-processing operation 1020 and processes each segmented region to detect and classify profile elements, extracting visual attributes including: profile image presence and quality indicators; account handle format and consistency indicators; bio text presence and density indicators; follower and following count display regions; post grid density, visual consistency, and content type indicators; and highlight or story reel presence and quantity indicators. The outputs of the computer vision extraction operation 1030 comprise detected visual profile attributes and identified text-containing regions. These outputs are transmitted from the computer vision extraction operation 1030 to the OCR and structured text parsing operation 1040.

The OCR and structured text parsing operation 1040 receives the detected visual profile attributes and text-containing regions from the computer vision extraction operation 1030 and applies optical character recognition to extract textual content from those regions, comprising: numeric statistics including follower count, following count, and post count values; bio text content; category labels and subject matter declarations; link presence indicators; and any other textual elements present in the profile layout. The extracted textual and numeric data is parsed into structured attribute fields and transmitted, together with the visual attributes received from the computer vision extraction operation 1030, to the profile signal computation operation 1050.

The profile signal computation operation 1050 receives the visual profile attributes from the computer vision extraction operation 1030 and the structured textual attributes from the OCR and structured text parsing operation 1040, and maps those combined attributes to defined Signal Object schema fields, producing the following Profile-Derived Signal Objects 1060:
a professionalism signal 1061, encoding visual quality and presentation consistency derived from profile image quality indicators, post grid visual consistency, and overall layout completeness, transmitted to the Signal Dependency Graph 410 as a raw evidence signal 420;
a visual brand alignment signal 1062, encoding the degree of aesthetic compatibility between the creator's profile visual presentation and the Brand Object's style parameters, derived by comparing extracted color palette, visual tone, and aesthetic category indicators against Brand Object attributes, transmitted to the Signal Dependency Graph 410 as a raw evidence signal 420;
a profile completeness signal 1063, encoding a data completeness score derived from the presence and quality of expected profile elements detected by the computer vision extraction operation 1030 and OCR and structured text parsing operation 1040, transmitted to the Signal Dependency Graph 410 as a raw evidence signal 420 and additionally transmitted to the data-awareness routing system 1200 as a data completeness indicator;
a niche clarity signal 1064, encoding the degree of content category focus sharpness discernible from the profile layout, derived from the specificity and consistency of category labels and bio text content extracted by the OCR and structured text parsing operation 1040, transmitted to the Signal Dependency Graph 410 as a raw evidence signal 420;
a risk flag signal 1065, encoding detected inconsistency, authenticity risk, or brand safety risk indicators derived from detected anomalies in follower-to-engagement ratios, bio text risk indicators, and content type inconsistencies, transmitted to the Signal Dependency Graph 410 as a raw evidence signal 420 and additionally contributing to the Risk Signal family within the signal layer 400, from which it may influence hard Constraint Object evaluation within the constraint engine; and
an audience indicator signal 1066, encoding follower statistic credibility markers derived from follower count, following count, and post count values extracted by the OCR and structured text parsing operation 1040 and analyzed for engagement ratio plausibility, transmitted to the Signal Dependency Graph 410 as a raw evidence signal 420.

All Profile-Derived Signal Objects 1060 produced by the profile signal computation operation 1050 are injected into the Signal Dependency Graph 410 as raw evidence signals 420 at Stage 1 of the graph and propagate upward through Stages 2, 3, and 4 to influence derived behavioral signals 430, cross-signal validation signals 440, and composite compatibility signals 450, which are ultimately transmitted to the decision engine 500. All Profile-Derived Signal Objects 1060 are additionally encoded in the evidence_references field of Explainability Artifacts generated by the explainability output layer 600, thereby enabling audit reconstruction of the profile analysis contribution to any Decision Object.

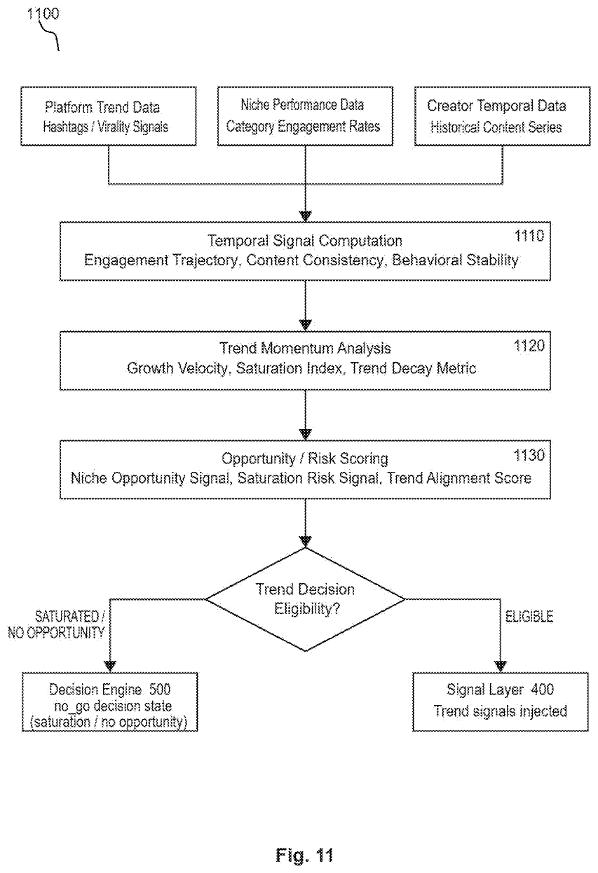

Referring to FIG. 11, in certain embodiments the signal layer 400 further comprises a trend intelligence sub-module 1100 configured to compute trend-derived Signal Objects from temporal and platform data inputs and to deliver those signals as bounded operational inputs to the decision engine 500. This sub-module is framed as a decision-grade component: its outputs are not trend discovery rankings or advisory outputs, but are structured Signal Objects and, in certain circumstances, hard constraint inputs that directly cause generation of a no_go decision state by the decision engine 500.

The trend intelligence sub-module 1100 receives three parallel input streams, all retrieved as Evidence Objects from the evidence data store by the evidence-weighted retrieval layer 300 and transmitted to the signal layer 400 as bounded Evidence Objects: platform trend data comprising hashtag performance metrics, virality signal indicators, and platform-specific trending content indicators; niche performance data comprising category-level engagement rate benchmarks, niche growth indices, and competitive density metrics; and creator temporal data comprising the creator's historical content series, engagement time-series records, and content publication cadence records.

In a first stage, a temporal signal computation operation 1110 receives the bounded Evidence Objects containing platform trend data, niche performance data, and creator temporal data from the signal layer 400 and applies time-series analysis functions to derive the following temporal signals: engagement trajectory signals, encoding the rate of change and directional trend of creator engagement metrics over a defined historical time window computed by moving average and trend regression functions applied to the creator temporal data; content consistency signals, encoding the degree of thematic and stylistic consistency in creator content production computed from the creator temporal data; and behavioral stability indicators, encoding the consistency of behavioral characteristics across multiple content samples computed from creator temporal data. The temporal signals produced by the temporal signal computation operation 1110 are transmitted to the trend momentum analysis operation 1120.

In a second stage, the trend momentum analysis operation 1120 receives the temporal signals from the temporal signal computation operation 1110 together with platform trend data and niche performance data bounded Evidence Objects, and computes the following momentum signals: an engagement growth velocity signal, encoding the rate of change of creator engagement metrics over a defined trailing time window computed by rate-of-change derivative functions; a saturation index signal, encoding the degree of niche market saturation computed from competitive density metrics and trend diffusion indicators within the niche performance data; and a trend decay metric signal, encoding the rate at which the relevant trend's engagement indicators are declining computed from time-series analysis of platform trend data. The momentum signals produced by the trend momentum analysis operation 1120 are transmitted to the opportunity and risk scoring operation 1130.

In a third stage, the opportunity and risk scoring operation 1130 receives the momentum signals from the trend momentum analysis operation 1120 and synthesizes them to produce the following composite trend signals: a niche opportunity signal encoding the assessed degree of available trend opportunity for the creator's content category; a saturation risk signal encoding the assessed probability that niche saturation will reduce campaign effectiveness; and a trend alignment score encoding the degree of alignment between the creator's content trajectory and current trend momentum in the relevant niche category. The composite trend signals produced by the opportunity and risk scoring operation 1130 are evaluated against a trend decision eligibility threshold.

If the composite trend signals satisfy the trend decision eligibility threshold, the trend intelligence sub-module 1100 injects the trend-derived Signal Objects into the Signal Dependency Graph 410 as derived behavioral signals 430 at Stage 2 of the graph, from which they propagate upward through cross-signal validation signals 440 at Stage 3 and composite compatibility signals 450 at Stage 4, and are ultimately transmitted to the decision engine 500 as inputs to soft constraint scoring 520 and confidence threshold evaluation 540.

If the composite trend signals indicate saturation or absence of trend opportunity for a trend-sensitive campaign objective, the trend intelligence sub-module 1100 generates a trend opportunity no_go signal and transmits it to the constraint engine of the decision engine 500 as a hard constraint input. Upon receipt of the trend opportunity no_go signal, the constraint engine immediately generates a no_go decision state for the relevant candidate creator through the hard constraint evaluation operation 510, without proceeding to soft constraint scoring 520, contradiction detection 530, or confidence threshold evaluation 540.

In certain embodiments, the signal layer 400 further performs temporal signal processing by computing temporal Signal Objects derived from time-series analysis of creator data across defined time windows. Temporal signal processing enables the system 10 to model creator performance dynamics rather than relying solely on static point-in-time evidence snapshots.

Temporal Signal Objects computed by the signal layer 400 include: engagement trajectory signals, encoding the rate of change and directional trend of engagement metrics over a defined historical time window; content consistency signals, encoding the degree of thematic and stylistic consistency in creator content production over time; behavioral stability indicators, encoding the consistency of behavioral characteristics observed in creator video content across multiple content samples over time; trend momentum indicators, encoding the velocity of growth or decline in creator niche category relevance; audience growth velocity signals, encoding the rate of change in creator audience size; and engagement decay metrics, encoding the rate at which historical content engagement decays over time.

Temporal Signal Objects are computed through application of time-series statistical functions, including moving averages, trend regression, and rate-of-change derivatives, to time-indexed Evidence Object arrays retrieved by the evidence-weighted retrieval layer 300. The resulting temporal Signal Objects are integrated into the Signal Dependency Graph 410 and contribute to composite compatibility signals 450, which are transmitted to the decision engine 500.

The signal layer 400 further performs confidence calibration operations on computed Signal Objects. Confidence calibration dynamically adjusts confidence estimates associated with Signal Objects based on: signal completeness, computed as the proportion of expected evidence inputs that were available for signal computation within the Signal Dependency Graph 410; signal agreement, computed as the degree of consistency among Signal Objects derived from different evidence sources for the same creator; cross-source evidence validation, encoding the result of consistency checks across Signal Objects derived from independent evidence sources; contradiction detection, encoding the presence and severity of contradictions identified among Signal Objects within the Signal Dependency Graph 410 and derived from the contradiction severity scores attached to Evidence Objects by the contradiction indicator computation operation 740 of the evidence-weighted retrieval layer 300; data recency, encoding the age of the Evidence Objects used in signal computation as computed from the recency scores assigned by the intake normalization layer 100; and source reliability, encoding the reliability class of the Evidence Object sources as assigned during provenance tagging by the intake normalization layer 100.

The confidence calibration operation ensures that confidence estimates attached to Signal Objects reflect not only the magnitude of the computed signal value but also the reliability and integrity of the evidence from which the signal was derived. Calibrated confidence estimates are propagated upward through the Signal Dependency Graph 410 and are transmitted together with composite compatibility signals 450 to the decision engine 500 as inputs 460 to the confidence threshold evaluation operation 540.

In certain embodiments, computed Signal Objects are persisted within a signal persistence layer comprising a signal storage data store indexed by creator identifier and signal identifier. The signal persistence layer receives Signal Objects from the signal layer 400 upon completion of signal computation and stores them for subsequent retrieval and reuse across multiple system workflows. Persisted Signal Objects may be retrieved by the signal layer 400 and reused without recomputing the complete signal pipeline for the relevant creator, conditioned upon signal recency validation, which verifies that the age of the persisted Signal Object does not exceed a defined recency threshold for the relevant signal family.

According to some aspects, signal reuse is supported across the following workflow contexts: creator discovery workflows, in which Signal Objects computed during an initial candidate evaluation are retrieved from the signal persistence layer and provided to the decision engine 500 for discovery gating decisions; pricing intelligence workflows, in which Pricing Suitability Signal Objects and pricing readiness signals 946 are retrieved from the signal persistence layer and provided to the decision engine 500 and negotiation control state machine for pricing decision state generation and negotiation constraint evaluation; campaign performance analysis workflows, in which Signal Objects are retrieved and used to compute performance attribution; organic content performance analysis workflows; and negotiation intelligence workflows, in which Signal Objects governing negotiation constraint parameters are retrieved without recomputation.

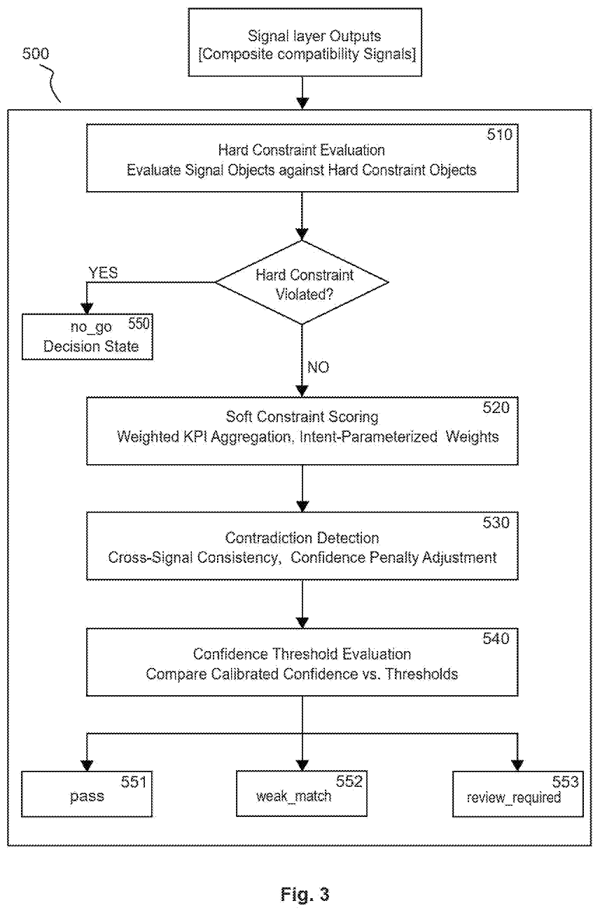

Referring to FIG. 3, the decision engine 500 constitutes the fifth computational stage of the system 10. The decision engine 500 incorporates a constraint engine as a dedicated evaluation subsystem. The constraint engine is not a threshold check performed as an incidental step within the decision engine; it is a distinct evaluation component that applies hard Constraint Objects, soft Constraint Objects, and contradiction-derived confidence penalties to the composite Signal Objects received from the signal layer 400, and that directly blocks downstream system execution when hard Constraint Objects are violated.

The decision engine 500 is configured to receive input 460 comprising composite compatibility signals 450 and their associated calibrated confidence estimates and uncertainty values from the signal layer 400, together with the Intent representation 210 and Context representation 220 received from the transformation layer 200, and the trend opportunity no_go signal when generated by the trend intelligence sub-module. The decision engine 500 applies a defined evaluation procedure to generate a bounded operational decision state and associated Decision Object for each candidate creator evaluated.

Signal Objects evaluated by the decision engine 500 are not scores. They are structured data objects carrying signal values, confidence estimates, uncertainty values, and dependency references. The decision engine 500 does not rank candidates against each other; it evaluates each candidate creator independently against defined Constraint Objects and confidence thresholds. The result of this evaluation is a bounded operational decision state, an operational system control command, not a ranking position or recommendation score.

The constraint engine constitutes a dedicated gatekeeping subsystem within the decision engine 500. It is not a threshold check performed as an incidental step; it is a distinct evaluation component that receives composite Signal Objects from the signal layer 400 and evaluates them against hard and soft Constraint Objects before any decision state generation occurs. The constraint engine operates in two sequential phases. In the first phase, hard constraint evaluation 510 is performed: any hard Constraint Object violation immediately causes the constraint engine to generate a no_go decision state and transmit it to the enforcement and routing layer 700, without proceeding to soft constraint scoring, contradiction detection, or confidence threshold evaluation. In the second phase, soft constraint scoring 520 is performed only for candidates that pass all hard constraints. The constraint engine thereby enforces absolute system boundaries and governs decision eligibility before the decision engine performs any reasoning over compatibility signals.

The constraint engine within the decision engine 500 first performs a hard constraint evaluation operation 510. In the hard constraint evaluation operation 510, the composite Signal Objects received from the signal layer 400 are evaluated against hard Constraint Objects populated from the Context representation 220 received from the transformation layer 200. Hard Constraint Objects encode absolute threshold conditions that must be satisfied for any positive decision state to be generated. Hard constraints may include, without limitation: minimum audience match score thresholds derived from the Context representation 220, below which a no_go decision state is mandatory; brand safety flag conditions populated from brand safety parameters of the Context representation 220, that trigger mandatory no_go states upon detection of content safety violations in the Risk Signal family or risk flag signal 1065; pricing floor conditions triggered when creator pricing indicated by the Pricing Suitability signal or pricing readiness signal 946 exceeds campaign budget parameters encoded in the Context representation 220; platform availability conditions triggered when Platform Availability signals indicate a creator is unavailable on required campaign platforms; content restriction conditions triggered when content domain labels produced by the natural language processing module 840 indicate content category violations; and the trend opportunity no_go signal transmitted directly from the trend intelligence sub-module.

If any hard Constraint Object is violated for a candidate creator, the constraint engine immediately generates a no_go decision state for that candidate and stores the violated constraint identifiers as reason codes within the resulting Decision Object. The no_go decision state is an operational system blocking output. It is not a low-relevance score or a negative recommendation. The no_go state generation does not require evaluation of remaining soft Constraint Objects or confidence thresholds. The resulting Decision Object encoding the no_go state is transmitted to the explainability output layer 600 and to the enforcement and routing layer 700, which executes the following blocking behaviors: excluding the affected candidate creator from all creator discovery interfaces visible to brand operators; suppressing all recommendation generation for the affected candidate; blocking negotiation workflow initiation for the affected candidate; and preventing all downstream workflow progression for the affected candidate.

For candidate creators whose Signal Objects satisfy all hard Constraint Objects in the hard constraint evaluation operation 510, the constraint engine performs a soft constraint scoring operation 520. In the soft constraint scoring operation 520, composite compatibility signals 450 received from the signal layer 400 are evaluated against soft Constraint Objects encoding desirable but non-absolute conditions. Each soft constraint evaluation produces a partial score that contributes to an aggregate compatibility score 155 according to a defined weighting scheme. Soft constraint weights are parameterized by the Intent representation 210 received from the transformation layer 200, such that signal dimensions corresponding to higher-priority campaign KPIs receive proportionally greater weight in the aggregate compatibility score 155. The aggregate compatibility score 155 produced by the soft constraint scoring operation 520 is transmitted to the contradiction detection operation 530.

Following soft constraint scoring, the decision engine 500 performs a contradiction detection operation 530. The contradiction detection operation 530 receives the cross-signal validation signals 440 generated by the Signal Dependency Graph 410 of the signal layer 400 and evaluates them to identify the presence and severity of contradictions among signals derived from independent evidence sources. Detected contradictions trigger confidence penalty adjustments that reduce the effective confidence estimate associated with the aggregate compatibility score 155 produced by the soft constraint scoring operation 520. Contradiction severity is encoded in the resulting Decision Object as a validation failure indicator. The confidence-adjusted aggregate compatibility score 155 is transmitted to the confidence threshold evaluation operation 540.

Following contradiction detection, the decision engine 500 performs a confidence threshold evaluation operation 540. The confidence threshold evaluation operation 540 receives the confidence-adjusted aggregate compatibility score 155 from the contradiction detection operation 530, together with the calibrated confidence estimates transmitted from the signal layer 400 with the composite compatibility signals 450, and compares the aggregate confidence estimate against a set of defined confidence threshold parameters. The confidence threshold evaluation determines the appropriate bounded operational decision state from the defined set.

The pass decision state 551 is generated when the aggregate compatibility score 155 meets or exceeds a defined pass threshold, the calibrated confidence estimate meets or exceeds a defined confidence threshold, and no hard or soft Constraint Object violations are detected that preclude a positive decision. The weak_match decision state 552 is generated when the aggregate compatibility score 155 falls within a defined weak match range below the pass threshold, indicating that the candidate may be viable with modified campaign parameters or under restricted conditions. The review_required decision state 553 is generated when the confidence estimate falls below a defined minimum confidence threshold, when contradiction severity encoded in the validation failure indicator exceeds a defined contradiction threshold, or when Data Completeness signals received from the signal layer 400 indicate insufficient evidence for a reliable automated decision. The no_go decision state 550 is generated upon hard Constraint Object violation as described above, or upon aggregate compatibility score 155 falling below a defined minimum viability threshold.

The decision engine 500 performs decision reasoning through a Decision Graph structure that explicitly models the weighted contribution of each Signal Object to the final bounded operational decision state, rather than applying a single aggregate threshold comparison. In the Decision Graph, each composite compatibility signal 450 carries an associated signal weight derived from the Intent representation 210, a calibrated confidence estimate propagated from the signal layer 400, and an uncertainty value reflecting the range of plausible signal values given available evidence. The Decision Graph evaluates these weighted, confidence-calibrated Signal Objects collectively to determine whether their combined evidentiary support satisfies the conditions for a positive decision state. Where Signal Objects conflict—for example, where a high Brand Alignment signal coexists with a high Risk signal, or where a strong Engagement Strength signal is accompanied by a low Data Completeness signal—the Decision Graph computes trade-off indicators that quantify the tension between the conflicting signals. These trade-off indicators are encoded in the Decision Object and populate the trade_off_indicators field of the Explainability Artifact generated by the explainability output layer 600. The Decision Graph thereby ensures that each bounded operational decision state is the product of structured multi-factor reasoning incorporating weighted signal contributions, contradiction-adjusted confidence, and explicitly modeled trade-offs between competing signal dimensions.

The bounded operational decision state, together with the Decision Object encoding the decision state, confidence score, uncertainty value, evidence references, reason codes, validation failure indicators, and trade-off indicators identifying tensions between conflicting Signal Objects, is transmitted from the decision engine 500 to the explainability output layer 600 and to the enforcement and routing layer 700.

In certain embodiments, the decision engine 500 implements a decision safety mechanism that suppresses positive decision state generation when signal completeness or calibrated confidence falls below defined safety thresholds. When safety thresholds are not met, the decision engine 500 does not generate a pass or weak_match decision state. Instead, the decision safety mechanism automatically triggers one or more of: an additional data retrieval request transmitted to the evidence-weighted retrieval layer 300 to attempt retrieval of additional bounded Evidence Objects for the affected candidate creator; a structured user input request transmitted to the data-awareness routing system 1200 routing the workflow to an intake module configured to collect additional evidence; or a decision output deferral pending completion of additional data collection. The decision safety mechanism prevents the system 10 from generating positive decision states based on insufficient evidence, thereby enforcing decision reliability standards as a computational system property rather than as a post-hoc quality control measure.

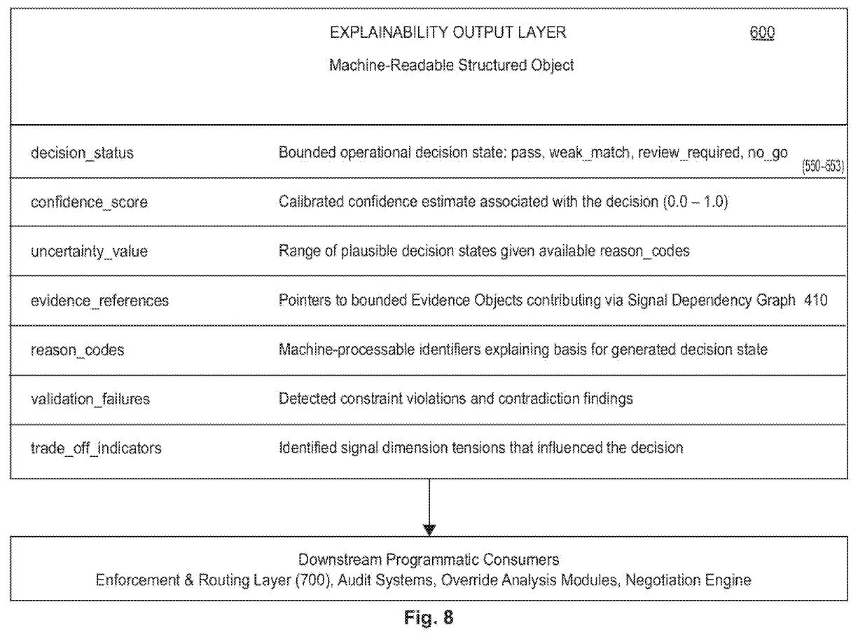

Referring to FIG. 8, the explainability output layer 600 constitutes the sixth computational stage of the system 10. The explainability output layer 600 is configured to receive Decision Objects generated by the decision engine 500 and to produce structured Explainability Artifacts. Explainability Artifacts are machine-readable structured system components and not user interface display elements. They are stored in the explainability data store and consumed programmatically by downstream system layers.

Each Explainability Artifact produced by the explainability output layer 600 is a machine-readable data structure comprising seven fields. The decision_status field encodes the bounded operational decision state received from the decision engine 500. The confidence_score field encodes the calibrated confidence estimate associated with the decision, expressed as a normalized numerical value derived from the confidence calibration operations of the signal layer 400 and the confidence penalty adjustments applied during contradiction detection 530. The uncertainty_value field encodes the range of plausible alternative decision states given the available evidence, derived from the uncertainty values carried by Signal Objects through the Signal Dependency Graph 410. The evidence_references field encodes structured pointers to the bounded Evidence Objects that contributed to the decision through the Signal Dependency Graph 410, enabling complete reconstruction of the evidentiary chain from bounded Evidence Objects through Signal Objects to the final Decision Object. The reason_codes field encodes machine-processable identifiers corresponding to defined decision basis categories that collectively explain the basis for the generated decision state. The validation_failures field encodes identifiers of any hard or soft Constraint Object violations detected during constraint evaluation, together with the constraint threshold values that were violated. The trade_off_indicators field encodes identified tensions between signal dimensions that influenced the decision, such as conflicts between high Engagement Strength signals and high Risk signals, derived from the trade-off analysis performed during confidence threshold evaluation 540.

Explainability Artifacts are stored in a structured explainability data store indexed by decision identifier, creator identifier, and campaign identifier. The Explainability Artifacts function as functional computational components of the system 10 rather than as user interface features: they are consumed programmatically by the enforcement and routing layer 700 to determine specific downstream system control actions based on the decision state and reason codes encoded therein; by downstream audit systems to reconstruct decision provenance from the evidence_references field by traversing the Signal Dependency Graph 410 back to the contributing bounded Evidence Objects; by override analysis modules to evaluate proposed manual overrides of system-generated Decision Objects by verifying that the proposed override is supported by evidence not reflected in the original decision; and by the negotiation control state machine to determine applicable negotiation constraint boundaries based on the confidence_score and decision_status fields.

The enforcement and routing layer 700 constitutes the seventh computational stage of the system 10 and is configured to receive Decision Objects from the decision engine 500 and Routing Objects generated as a function of Decision Objects, and to execute downstream system control behaviors as a function of the bounded operational decision states encoded therein. The enforcement and routing layer 700 transforms the system 10 from a decision-generating architecture into a system control architecture by directly governing the behavioral state of downstream system components.

Downstream system control behaviors executed by the enforcement and routing layer 700 include:
Discovery gating, comprising the hiding or exclusion of candidate creators carrying no_go decision states from creator discovery interfaces visible to brand operators, such that no_go candidates are not presented for brand operator review under any circumstances;
Recommendation suppression, comprising the blocking of campaign recommendation generation for candidate creators carrying no_go or review_required decision states, preventing the system 10 from surfacing those candidates as recommended partners;
Negotiation initiation control, comprising the blocking of negotiation workflow initiation for candidate creators carrying no_go decision states, preventing both automated and operator-initiated outreach to ineligible candidates;
Manual review routing, comprising the generation of structured manual review work items for candidate creators carrying review_required decision states, routed to designated review queues with attached Explainability Artifacts received from the explainability output layer 600;
Workflow routing, comprising the dynamic routing of operator workflows to alternative system states based on decision state outputs, including routing to additional intake modules when data completeness signals from the signal layer 400 indicate insufficient evidence; and
Negotiation control state machine initiation, comprising, in certain embodiments, the initiation of a constraint-governed negotiation control state machine for candidate creators carrying pass or weak_match decision states, as further described below.

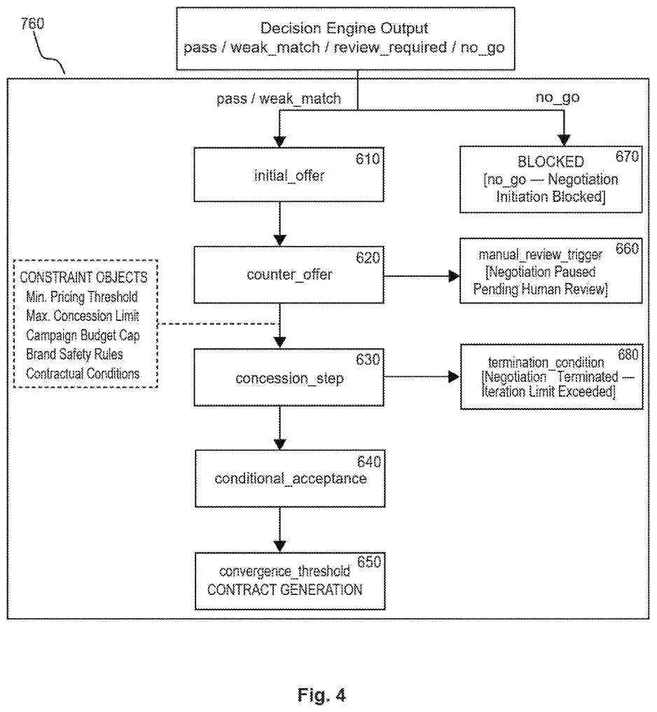

Referring to FIG. 4, in certain embodiments, the system 10 further comprises a constraint-governed negotiation control state machine 760 within the enforcement and routing layer 700, that is initiated and controlled by decision outputs generated by the decision engine 500, as a downstream control behavior executed by the enforcement and routing layer 700. The negotiation state machine 760 implements an automated negotiation workflow between a brand entity and a creator entity within system-defined operational constraints. The negotiation workflow is a downstream control mechanism of the decision control architecture, not an independent AI negotiator.

The negotiation state machine 760 is a finite state machine comprising defined negotiation states and state transition conditions. Negotiation states of the state machine 760 include: initial_offer state 610, in which the system 10 generates an initial offer for transmission to the creator entity based on the campaign budget parameters encoded in the Context representation 220 and the Pricing Suitability signals transmitted from the signal layer 400; counter_offer state 620, in which a counter-offer from the creator entity is received and evaluated against negotiation Constraint Objects; concession_step state 630, in which the system 10 computes a permitted concession within defined concession allowance parameters and transmits an updated offer; conditional_acceptance state 640, in which the parties have reached a conditional agreement pending satisfaction of defined conditions; convergence_threshold state 650, in which the parties have converged on terms within the defined acceptance range, triggering contract generation; termination_condition state 680, in which negotiation is terminated upon failure to converge within defined iteration limits; and manual_review_trigger state 660, in which negotiation is paused and routed to manual review upon detection of conditions exceeding automated handling parameters.

State transitions within the negotiation state machine 760 are controlled by the decision engine 500 and enforced by the enforcement and routing layer 700 according to the following rules. When the decision engine 500 generates a pass decision state, negotiation initiation is permitted and the negotiation state machine 760 proceeds through its full state sequence within defined constraint boundaries. When the decision engine 500 generates a weak_match decision state, negotiation initiation is permitted with a restricted concession allowance range, limiting the maximum concession the system 10 will generate during concession_step state 630. When the decision engine 500 generates a review_required decision state, the negotiation state machine 760 is routed to manual_review_trigger state 660, pausing automated negotiation pending human operator review. When the decision engine 500 generates a no_go decision state, negotiation initiation is blocked 670 and the negotiation state machine 760 is not initiated for the relevant candidate.

The negotiation state machine 760 further enforces negotiation constraints at each state transition through a negotiation constraint evaluation operation. Negotiation constraints enforced by the state machine 760 include: minimum acceptable pricing thresholds, below which the system 10 will not accept creator offers; maximum concession allowances, beyond which concession_step state 630 is not permitted; campaign budget limit constraints, beyond which total compensation commitments are blocked; brand safety constraints, upon violation of which negotiation is immediately terminated; and contractual compliance conditions, comprising legal and regulatory compliance requirements evaluated at each state transition. The negotiation state machine 760 generates negotiation Explainability Artifacts at each state transition, comprising: negotiation decision status encoding the current state; applied negotiation constraint identifiers; pricing boundary references encoding the constraints governing the current state; reason codes for any state transitions resulting from constraint violations; and confidence indicators for negotiation viability based on the convergence trajectory.

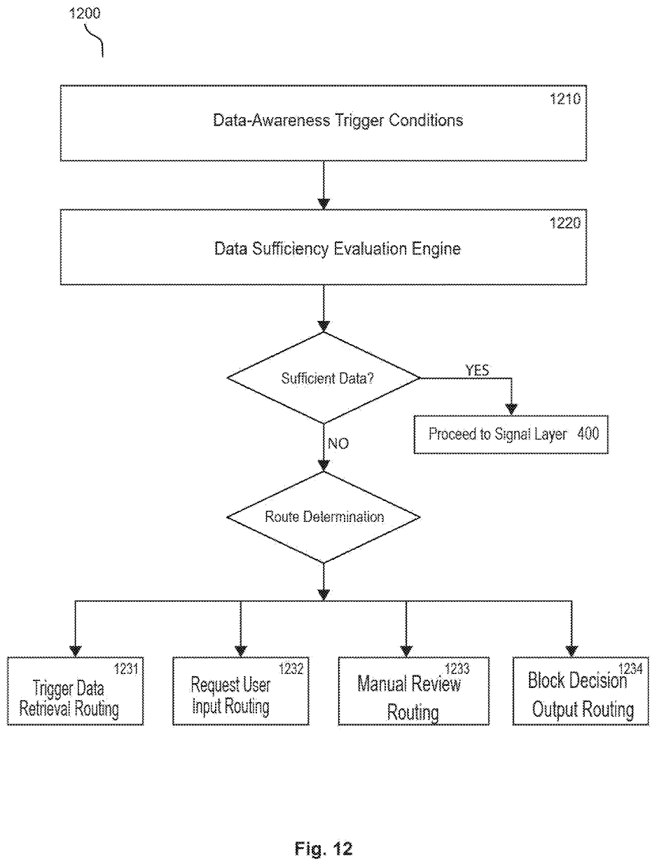

Referring to FIG. 12, the system 10 implements a data-awareness routing system 1200 as a dedicated control subsystem that governs pipeline execution state based on the completeness, confidence, and quality of available data at each stage of the processing pipeline. The data-awareness routing system 1200 is not a user interface component or a chat routing mechanism. It is an internal control architecture that determines whether the system's processing pipeline should proceed to the signal layer 400, pause for additional data collection, or block decision output generation, based on programmatically evaluated data sufficiency conditions.

The data-awareness routing system 1200 is activated by data-awareness trigger conditions 1210 that are evaluated throughout the processing pipeline. Trigger conditions comprise: missing required data, detected when one or more required Evidence Object fields are absent from the bounded Evidence Object set transmitted by the evidence-weighted retrieval layer 300; low confidence, detected when calibrated confidence estimates transmitted from the signal layer 400 fall below a defined minimum confidence threshold; incomplete evidence, detected when Data Completeness signals transmitted from the signal layer 400 indicate that evidence coverage for a candidate creator falls below a defined minimum coverage threshold; missing pricing data, detected when Pricing Suitability Signal Objects or pricing readiness signals 946 required for negotiation-related decision states are absent from the bounded Evidence Object set; and missing platform data, detected when Platform Availability signals indicate that evidence covering required campaign platforms is absent from the bounded Evidence Object set. The data availability flags generated by the intake normalization layer 100 upon consent absence are also transmitted to the data-awareness routing system 1200 as trigger conditions.

Upon detection of one or more trigger conditions, the data-awareness routing system 1200 activates the Data Sufficiency Evaluation Engine 1220, which receives the detected trigger conditions and evaluates the following metrics: a signal completeness score, computed as the proportion of expected Signal Objects that were successfully computed by the signal layer 400 given the available bounded Evidence Objects; a confidence threshold check, comparing the aggregate calibrated confidence estimate transmitted from the signal layer 400 against a defined sufficiency threshold; and an evidence coverage assessment, evaluating whether the available bounded Evidence Objects provide sufficient coverage across all required decision dimensions for the candidate creator.

If the Data Sufficiency Evaluation Engine 1220 determines that available data is sufficient, the data-awareness routing system 1200 permits the processing pipeline to proceed normally to the signal layer 400. If the Data Sufficiency Evaluation Engine 1220 determines that data is insufficient, the data-awareness routing system executes one of four routing actions based on the nature and severity of the detected deficiency.

A trigger additional data retrieval routing action 1231 is executed when missing required evidence fields or missing platform data trigger conditions are detected and additional evidence may be retrievable. The data-awareness routing system 1200 re-invokes the evidence-weighted retrieval layer 300 with augmented Retrieval-Key parameters derived from the identified missing data dimensions, directing the evidence-weighted retrieval layer 300 to execute additional parameterized retrieval queries against the evidence data store to attempt retrieval of additional Evidence Objects for the affected candidate creator.

A request structured user input routing action 1232 is executed when the missing data cannot be retrieved from existing data stores and requires collection from the creator operator or brand operator. The data-awareness routing system 1200 routes the workflow to a defined intake module configured to receive structured input from the relevant operator through the creator operator portal interface or brand operator dashboard interface, specifying the particular data fields required to satisfy the identified deficiency.

A route to manual review routing action 1233 is executed when the data deficiency is of a nature that cannot be resolved through automated retrieval or structured user input, or when detected data quality anomalies require human operator assessment. The data-awareness routing system 1200 generates a structured manual review work item for the affected candidate creator, attaches the Explainability Artifact generated by the explainability output layer 600 encoding the data deficiency reason codes, and routes the work item to a designated human operator review queue within the enforcement and routing layer 700.

A block decision output routing action 1234 is executed when signal completeness or confidence falls below defined safety thresholds that preclude generation of a reliable Decision Object. The data-awareness routing system 1200 activates the decision safety mechanism of the decision engine 500, which suppresses generation of any pass or weak_match decision state for the affected candidate creator, as described above in connection with the decision safety mechanism.

The data-awareness routing system 1200 thereby functions as a system-level data quality enforcement architecture governing pipeline execution state. It ensures that Decision Objects are generated only when underlying evidence meets defined minimum sufficiency standards, and actively routes the system 10 to appropriate remediation workflows when those standards are not met. This routing behavior directly governs whether and how the system's processing pipeline executes, independent of any user interface interaction.

According to another exemplary embodiment of the present invention, a method involving the complete processing workflow of the system 10, from initial data reception to downstream control execution, proceeds through the following sequential computational stages.

Prior to execution of the normalization pipeline, the system 10 performs a creator content ingestion step. In the creator content ingestion step, a creator operator accesses the creator operator portal interface and either uploads a video file directly to the system 10 or submits a platform-specific content link from which the system 10 retrieves the corresponding video asset. Upon submission, the system 10 presents a consent interface to the creator operator specifying the nature of the multi-modal analysis to be performed and the purposes for which the resulting data will be used. The system 10 records a time-stamped digital consent record upon the creator operator's affirmative acceptance and stores creator video content 810 in the creator data store. If consent is not provided, the system 10 halts ingestion of the submitted content and generates a data availability flag indicating consent absence, which is transmitted to the data-awareness routing system 1200 as a trigger condition; no further processing of the submitted content is performed. The creator video content 810 produced by this ingestion step is subsequently consumed as input by the behavioral and affective video analysis sub-module 800 during signal computation.

Initially, the intake normalization layer 100 receives raw creator-marketing data inputs from heterogeneous sources and performs schema normalization, field validation, missingness handling, provenance tagging, temporal normalization, and platform normalization to produce normalized data objects comprising Brand Objects, Campaign Objects, and Creator Objects annotated with provenance metadata, validation flags, completeness scores, and recency scores. The normalized data objects are transmitted to the transformation layer 200.

The transformation layer 200 receives the normalized data objects from the intake normalization layer 100 and transforms them into an Intent representation 210, a Context representation 220, and a Retrieval-Key attribute set 230 through defined deterministic computational transformation functions. The Intent representation 210 and Context representation 220 are transmitted to the decision engine 500 for use in parameterizing constraint evaluation and soft constraint weighting. The Retrieval-Key attribute set 230 is transmitted to the evidence-weighted retrieval layer 300.

The evidence-weighted retrieval layer 300 receives the Retrieval-Key attribute set 230 from the transformation layer 200 and executes parameterized retrieval queries against the creator data store to retrieve candidate Creator Objects and against the evidence data store to retrieve associated Evidence Objects. The evidence weighting evaluation operation 730 evaluates each Evidence Object, the contradiction indicator computation operation 740 detects cross-source inconsistencies, and the bounded evidence gating operation 750 applies the technical gate, producing bounded Evidence Objects that are transmitted to the signal layer 400.

The data-awareness routing system 1200 evaluates data sufficiency conditions based on the bounded Evidence Objects received from the evidence-weighted retrieval layer 300 and the data completeness flags produced by the intake normalization layer 100. If evidence is insufficient, the appropriate routing action is executed. If evidence is sufficient, the signal layer 400 receives the bounded Evidence Objects and computes intermediate Signal Objects through the Signal Dependency Graph 410, including behavioral Signal Objects 860 from the behavioral and affective video analysis sub-module 800, Bio-Derived Signal Objects 940 from the bio-derived signal sub-module, Profile-Derived Signal Objects 1060 from the profile health analysis sub-module, trend-derived Signal Objects from the trend intelligence sub-module, and temporal Signal Objects from time-series analysis. Confidence calibration is performed on all computed Signal Objects, and Signal Objects are persisted in the signal persistence layer as applicable. Composite compatibility signals 450 with calibrated confidence estimates are transmitted from the signal layer 400 to the decision engine 500.

The decision engine 500 receives composite compatibility signals 450 and their associated calibrated confidence estimates from the signal layer 400, together with the Intent representation 210 and Context representation 220 from the transformation layer 200. The constraint engine performs hard constraint evaluation 510 against hard Constraint Objects populated from the Context representation 220, and, for candidates passing hard constraint evaluation, soft constraint scoring 520 parameterized by the Intent representation 210. Contradiction detection 530 receives cross-signal validation signals 440 from the signal layer 400 and applies confidence penalty adjustments. Confidence threshold evaluation 540 generates the bounded operational decision state. The Decision Object encoding the bounded decision state, confidence score, uncertainty value, evidence references, reason codes, validation failures, and trade-off indicators is transmitted to the explainability output layer 600 and the enforcement and routing layer 700.

The explainability output layer 600 receives the Decision Object from the decision engine 500 and generates a structured Explainability Artifact comprising all seven fields described herein. The Explainability Artifact is stored in the explainability data store and transmitted to the enforcement and routing layer 700.

The enforcement and routing layer 700 receives the Decision Object from the decision engine 500 and the Explainability Artifact from the explainability output layer 600 and executes downstream system control behaviors including discovery gating, recommendation suppression, negotiation initiation control, manual review routing, and workflow routing as a function of the bounded operational decision state. In certain embodiments, the enforcement and routing layer 700 initiates the constraint-governed negotiation state machine 760 for candidate creators carrying pass or weak_match decision states.

In certain embodiments, the bounded operational decision state generated by the decision engine 500 functions as a control signal for downstream campaign-spend workflows. Specifically, the enforcement and routing layer 700 receives the bounded operational decision state and, in response thereto, controls one or more of campaign budget allocation, campaign approval, negotiation initiation, offer generation, or contract generation, such that a no_go decision state prevents the relevant workflow from executing, and a review_required decision state pauses the relevant workflow pending evidence-sufficient re-evaluation or operator review. The pause-and-prevent behavior is parameterized by at least one of: a pricing constraint derived from creator pricing readiness signals 946 or campaign Pricing Suitability Constraint Objects; a campaign budget cap encoded in the Context representation 220; a brand-safety rule encoded in the Context representation 220; a confidence threshold of the confidence threshold evaluation 540; a validation failure indicator encoded in the Decision Object; or a contradiction indicator computed by the contradiction detection operation 530. Through this control behavior, the system 10 protects influencer-marketing budgets prior to spend approval. The budget-protection control behavior is a downstream technical embodiment of the bounded operational decision state and the enforcement and routing layer 700, and is not a limitation of the underlying decision-control architecture.

The system 10 provides user interface components configured to enable brand operators and creator operators to interact with the decision control architecture. A brand operator dashboard interface is configured to: receive brand identity and campaign parameter inputs through wizard-style guided input forms that populate the Brand Object and Campaign Object transmitted to the intake normalization layer 100; display candidate creators with their associated Decision Objects and summary Explainability Artifacts received from the enforcement and routing layer 700; provide filter controls that parameterize Constraint Objects within the transformation layer 200; and display workflow routing outcomes generated by the enforcement and routing layer 700.

A creator operator portal interface is configured to: receive creator registration inputs; receive creator content video uploads or content platform links for ingestion into the creator content ingestion step; present the consent interface required for video content analysis; and, in certain embodiments, display brands carrying compatible decision profiles as determined by the decision engine 500.

The system 10 employs a secure, multi-tier data storage architecture comprising: a creator data store holding Creator Objects indexed by creator identifier and platform identifier; an evidence data store holding Evidence Objects indexed by creator identifier and evidence type; a signal storage data store holding persisted Signal Objects indexed by creator identifier and signal identifier; a decision data store holding Decision Objects indexed by creator identifier and campaign identifier; an explainability data store holding Explainability Artifacts indexed by decision identifier, creator identifier, and campaign identifier; and a constraint data store holding Constraint Objects indexed by constraint identifier and campaign identifier.

All data stores are secured through access control mechanisms that restrict read and write permissions to authorized system components. Creator content data is processed only upon valid consent record verification as described above. All stored data is annotated with provenance metadata and temporal identifiers to support audit trail reconstruction from Explainability Artifacts.

The decision control architecture of the present invention is applicable to a plurality of creator-marketing use cases beyond the primary embodiment described above. Alternative embodiments include:
A pricing intelligence embodiment in which the signal layer 400 computes Pricing Suitability Signal Objects and pricing readiness signals 946 from bounded Evidence Objects including creator rate card data and market rate benchmarks, and transmits those Signal Objects to the decision engine 500, which generates pricing decision states that are transmitted to the enforcement and routing layer 700 to govern automated pricing recommendation and negotiation initiation, and to the negotiation state machine 760 to parameterize minimum acceptable pricing thresholds and maximum concession allowances;
A campaign performance analysis embodiment in which historical campaign performance data is ingested by the intake normalization layer 100, normalized into Campaign Objects annotated with performance metadata, and transmitted through the transformation layer 200 and evidence-weighted retrieval layer 300 to the signal layer 400, which computes performance attribution Signal Objects that are transmitted to the decision engine 500 to generate campaign continuation or modification decision states, which are executed by the enforcement and routing layer 700 as workflow routing actions;
An organic content performance analysis embodiment in which creator organic content performance data is ingested by the intake normalization layer 100 and transmitted as bounded Evidence Objects to the behavioral and affective video analysis sub-module 800, which extracts engagement quality Signal Objects from the organic content and injects them into the Signal Dependency Graph 410, from which they propagate to composite compatibility signals 450 transmitted to the decision engine 500 to generate decision states governing creator partnership recommendations;
A screenshot-based profile health analysis embodiment in which profile screenshot captures 1010 submitted by creator operators are ingested by the intake normalization layer 100, stored in the creator data store, retrieved as bounded Evidence Objects by the evidence-weighted retrieval layer 300, and transmitted to the profile health analysis sub-module 1000 of the signal layer 400, which executes the image pre-processing 1020, computer vision extraction 1030, OCR and structured text parsing 1040, and profile signal computation 1050 operations to produce Profile-Derived Signal Objects 1060, which are injected into the Signal Dependency Graph 410, propagate to composite compatibility signals 450, and are transmitted to the decision engine 500 where the risk flag signal 1065 contributes to hard constraint evaluation 510 and the remaining Profile-Derived Signal Objects contribute to soft constraint scoring 520;
A trend intelligence embodiment in which platform trend data, niche performance data, and creator temporal data are ingested by the intake normalization layer 100, normalized, transmitted through the transformation layer 200 and evidence-weighted retrieval layer 300 as bounded Evidence Objects to the trend intelligence sub-module 1100 of the signal layer 400, which performs temporal signal computation 1110, trend momentum analysis 1120, and opportunity and risk scoring 1130, and either injects trend signals into the Signal Dependency Graph 410 when the trend decision eligibility threshold is satisfied or transmits a trend opportunity no_go signal to the constraint engine of the decision engine 500 as a hard constraint input, causing immediate generation of a no_go decision state that is transmitted to the enforcement and routing layer 700 to execute discovery gating and negotiation blocking;
A chat routing control embodiment in which the enforcement and routing layer 700 receives Decision Objects from the decision engine 500 and controls the routing of operator chat interactions to automated response systems, manual review queues, or negotiation state machine 760 initiation based on the bounded operational decision states encoded in those Decision Objects; and
A briefless baseline decision gating embodiment in which the decision engine 500 receives composite compatibility signals 450 from the signal layer 400 computed from persisted Signal Objects retrieved from the signal persistence layer in the absence of a specific campaign brief, and evaluates those signals against default Constraint Objects populated from generalized compatibility parameters, generating baseline decision states that are transmitted to the enforcement and routing layer 700 to execute discovery gating preventing display of candidates whose Signal Objects fall below defined minimum viability thresholds.

The present invention provides the following technical improvements over prior art creator-marketing systems: the no_go decision state is an operational system blocking output generated by the decision engine 500 and transmitted to the enforcement and routing layer 700, which directly blocks discovery visibility, recommendation generation, negotiation initiation, and workflow progression for the affected candidate. The blocking capability has no equivalent in prior art ranking systems that always produce ranked output regardless of constraint violations; the Signal Dependency Graph 410 enables hierarchical signal propagation from raw evidence signals 420 through derived behavioral signals 430, cross-signal validation signals 440, and composite compatibility signals 450, providing a structured computational basis for confidence calibration and evidence-linked explainability not achievable through flat scoring heuristics; the bounded evidence gating operation 750 enforces a non-optional technical gate on evidence quality before signal computation, ensuring that Signal Objects and Decision Objects are computed only from evidence meeting defined minimum reliability standards; the bio-derived signal sub-module, profile health analysis sub-module, and trend intelligence sub-module 1100 extend the Signal Dependency Graph's evidence coverage to creator biography, visual profile presentation, and temporal trend data dimensions not accessible through engagement metrics or platform APIs; Explainability Artifacts generated by the explainability output layer 600 are machine-readable system components consumed programmatically by the enforcement and routing layer 700, audit systems, override analysis modules, and the negotiation state machine 760, enabling programmatic decision provenance reconstruction and override validation; the data-awareness routing system 1200 enforces data quality as a pipeline execution prerequisite, routing the system 10 to remediation when evidence sufficiency thresholds are not met and activating the decision safety mechanism when safety thresholds are violated; and signal persistence enables Signal Objects to be reused across discovery, pricing, campaign analysis, organic analysis, and negotiation workflows without recomputation, ensuring consistent evidentiary foundations across workflow contexts.

The system 10 described herein is embodied as a computer-implemented system executing on one or more hardware processors in conjunction with one or more non-transitory computer-readable storage media storing processor-executable instructions that, when executed by the one or more hardware processors, cause the processors to implement the multi-layer decision control architecture described herein. Non-transitory computer-readable storage media include, without limitation, magnetic storage media such as hard disk drives and magnetic tape; optical storage media such as compact discs and digital versatile discs; flash memory devices; solid-state drives; and any other tangible storage medium capable of storing processor-executable instructions. The term “non-transitory” expressly excludes transitory propagating signals but does not exclude storage media capable of storing data in a persistent or semi-persistent manner.

In certain embodiments, the system 10 is implemented on a single computing device comprising at least one hardware processor, system memory, and persistent storage. In other embodiments, the system 10 is implemented as a distributed computing system in which the functions of individual layers are allocated across a plurality of computing nodes interconnected by a communications network. In such distributed embodiments, the intake normalization layer 100, signal layer 400, and decision engine 500 may execute on separate hardware nodes, with inter-layer communication occurring via application programming interfaces, message queuing systems, or event-driven communication buses. The distribution of processing functions across nodes does not alter the logical architecture of the system 10 as described herein.

The system 10 is suitable for deployment across on-premises server infrastructure; public cloud computing platforms including IaaS, PaaS, and SaaS environments; private cloud environments; hybrid cloud environments; edge computing environments in which certain processing functions such as intake normalization are performed near the data source; and containerized deployment environments. The system architecture is platform-agnostic and does not depend upon any particular operating system, hardware architecture, or cloud service provider. In embodiments implementing the system 10 as a microservices architecture, individual system layers may be packaged as independently deployable service units communicating via defined API contracts and scaled, updated, or replaced independently without altering the logical architecture.

The foregoing detailed description sets forth specific embodiments of the present invention for purposes of explanation and illustration. The description is not intended to be exhaustive or to limit the invention to the precise forms disclosed. Persons having ordinary skill in the art will recognize that numerous modifications, variations, and equivalents are possible in light of the above description without departing from the scope and spirit of the invention as defined by the appended claims.

While the invention has been described with reference to specific layers, modules, data structures, and processing sequences, the claimed invention is not limited to any particular implementation thereof. The reference numerals 100 through 1234, and the specific names assigned to data objects, signal families, decision states, and negotiation states are used for clarity of description only and do not limit the scope of the claims. Equivalent architectural arrangements that perform substantially the same functions in substantially the same way to achieve substantially the same results are within the scope of the invention.

The use of the terms “comprising,” “including,” “having,” and grammatical variants thereof in the claims and specification is intended to be open-ended and non-exhaustive. The use of ordinal terms does not imply a particular order of performance, priority, or importance unless expressly required by the claim language. Steps of method claims may be performed in any order that is logically consistent with the described functionality unless a specific sequence is required by the claim language.

Nothing in this specification shall be construed as an admission that any particular element, step, or feature described herein is prior art. No disclaimer of claim scope is intended or should be implied from any statement in this specification unless the statement expressly and unambiguously disclaims claim scope. The present invention, including all embodiments, variations, and equivalents described herein, is defined solely and exclusively by the claims appended hereto. The applicant expressly reserves the right to pursue claims of any scope consistent with the disclosure herein, including claims broader, narrower, or different in scope from those presented in this application, in continuation applications or in any reexamination, reissue, or post-grant proceeding.

1. A computer-implemented system comprising:
one or more hardware processors; and
one or more non-transitory computer-readable storage media storing instructions that, when executed by the one or more hardware processors, cause the system to implement a creator-marketing decision architecture comprising:
a brand profiling module configured to receive brand identity inputs through a structured questionnaire interface and to produce a Brand Profile Vector encoding numerical representations of brand style attributes, emotional tone parameters, and campaign objectives;
a behavioral and affective video analysis sub-module configured to process creator video content through a computer vision module to extract a visual feature vector, through a voice and speech analysis module to extract an audio feature vector, and through a natural language processing module to extract a text feature vector, and to combine the visual feature vector, audio feature vector, and text feature vector through a fusion component to produce a unified Creator Profile representation;
a compatibility scoring engine that computes a compatibility score between the Brand Profile Vector and the Creator Profile representation;
a signal layer configured to receive bounded Evidence Objects including the compatibility score and to compute a plurality of intermediate Signal Objects, wherein each Signal Object encodes a signal value, a confidence estimate, an uncertainty value, and dependency references to contributing Evidence Objects or Signal Objects; and
a decision engine configured to receive intermediate Signal Objects and Constraint Objects derived from the compatibility score and to generate a bounded operational decision state selected from the group consisting of pass, weak_match, review_required, and no_go together with a Decision Object encoding the decision state, confidence score, uncertainty value, evidence references, reason codes, validation failure indicators, and trade-off indicators.

2. The system of claim 1, further comprising:
an explainability output layer configured to receive the Decision Object and to generate a structured Explainability Artifact comprising decision_status, confidence_score, uncertainty_value, evidence_references, reason_codes, validation_failures, and trade_off_indicators fields, and to store the Explainability Artifact in an explainability data store; and
an enforcement and routing layer configured to receive the Decision Object and the Explainability Artifact and to execute downstream system control behaviors comprising discovery gating, recommendation suppression, negotiation initiation control, manual review routing, and workflow routing, based on the bounded operational decision state.

3. The system of claim 1, wherein the system is further configured to present a consent interface to a creator operator prior to any processing of creator video content, to record a time-stamped digital consent record upon affirmative acceptance, and to proceed with video content processing only upon verification of a valid consent record, wherein absence of a valid consent record causes the system to halt all processing of the submitted content and generate a data availability flag.

4. The system of claim 2, wherein the decision engine further comprises a constraint engine configured to perform hard constraint evaluation against hard Constraint Objects before any soft constraint scoring, wherein detection of a hard Constraint Object violation causes the constraint engine to immediately generate a no_go decision state without evaluating remaining soft Constraint Objects or confidence thresholds, and wherein the no_go decision state causes the enforcement and routing layer to exclude the relevant candidate creator from all creator discovery interfaces, suppress all recommendation generation, block negotiation workflow initiation, and prevent all downstream workflow progression.

5. The system of claim 1, wherein the signal layer organizes signal computation within a hierarchical Signal Dependency Graph comprising raw evidence signals at a first stage computed from bounded Evidence Objects, derived behavioral signals at a second stage computed from the raw evidence signals, cross-signal validation signals at a third stage computed using contradiction detection functions and confidence calibration functions, and composite compatibility signals at a fourth stage derived from the cross-signal validation signals through weighted aggregation, wherein the composite compatibility signals constitute the primary inputs to the decision engine.

6. The system of claim 1, further comprising a transformation layer configured to receive normalized data objects from an intake normalization layer and to transform the normalized data objects into an Intent representation encoding campaign decision objectives, a Context representation encoding operational constraints, and a Retrieval-Key attribute set encoding machine-generated candidate retrieval parameters, wherein the Brand Profile Vector produced by the brand profiling module contributes to the derivation of the Intent representation and the Context representation.

7. The system of claim 1, wherein the signal layer further comprises a bio-derived signal sub-module configured to receive creator biographical text, apply natural language processing to produce parsed bio attributes, and produce Bio-Derived Signal Objects comprising a niche indicator signal, an authority marker signal, a positioning signal, a brand alignment cue signal, a risk indicator signal, and a pricing readiness signal, wherein the Bio-Derived Signal Objects are injected into the Signal Dependency Graph as raw evidence signals.

8. The system of claim 1, wherein the signal layer further comprises a profile health analysis sub-module configured to receive a profile screenshot capture, apply image pre-processing and computer vision extraction to detect profile elements, apply OCR and structured text parsing to extract textual attributes, and produce Profile-Derived Signal Objects comprising a professionalism signal, a visual brand alignment signal, a profile completeness signal, a niche clarity signal, a risk flag signal, and an audience indicator signal, wherein the Profile-Derived Signal Objects are injected into the Signal Dependency Graph as raw evidence signals.

9. The system of claim 1, wherein the signal layer further comprises a trend intelligence sub-module configured to receive platform trend data, niche performance data, and creator temporal data, compute temporal signals and momentum signals, and produce composite trend signals, wherein the composite trend signals are injected into the signal layer as derived behavioral signals when a trend decision eligibility threshold is satisfied, and wherein upon detecting saturation or absence of trend opportunity the sub-module transmits a trend opportunity no_go signal to the decision engine as a hard constraint input.

10. The system of claim 2, further comprising a data-awareness routing system configured to detect data-awareness trigger conditions, evaluate data sufficiency through a Data Sufficiency Evaluation Engine, and upon determining that data is insufficient execute at least one of triggering additional data retrieval, routing the workflow to a structured user input intake module, generating a manual review work item with an attached Explainability Artifact, or activating a decision safety mechanism of the decision engine.

11. The system of claim 1, wherein the signal layer further comprises a signal persistence layer configured to store computed Signal Objects indexed by creator identifier and signal identifier, wherein stored Signal Objects are retrievable for reuse across discovery, pricing intelligence, campaign performance analysis, organic content analysis, and negotiation intelligence workflows, conditioned upon verification that the Signal Object age does not exceed a defined recency threshold for the relevant signal family.

12. The system of claim 5, wherein the signal layer is further configured to compute temporal Signal Objects from time-indexed Evidence Object arrays, wherein the temporal Signal Objects encode engagement trajectory signals, content consistency signals, behavioral stability indicators, trend momentum indicators, audience growth velocity signals, and engagement decay metrics, and wherein the temporal Signal Objects are integrated into the Signal Dependency Graph and contribute to the composite compatibility signals.

13. The system of claim 5, wherein the signal layer is further configured to perform confidence calibration on computed Signal Objects by adjusting confidence estimates based on signal completeness, signal agreement, cross-source evidence validation, contradiction detection outputs, data recency, and source reliability, and wherein calibrated confidence estimates are propagated upward through the Signal Dependency Graph to the decision engine.

14. The system of claim 1, wherein the decision engine is further configured to implement a decision safety mechanism that suppresses generation of pass or weak_match decision states when signal completeness or calibrated confidence falls below defined safety thresholds.

15. The system of claim 2, further comprising a constraint-governed negotiation control state machine configured to be initiated upon generation of a pass or weak_match decision state, comprising negotiation states including initial_offer, counter_offer, concession_step, conditional_acceptance, convergence_threshold, termination_condition, and manual_review_trigger, wherein state transitions are controlled by the decision engine and enforced by the enforcement and routing layer, and wherein a no_go decision state blocks initiation of the negotiation control state machine.

16. The system of claim 15, wherein the negotiation control state machine enforces negotiation Constraint Objects comprising minimum acceptable pricing thresholds, maximum concession allowances, campaign budget limit constraints, brand safety constraints, and contractual compliance conditions, and wherein violation of a negotiation Constraint Object causes the negotiation control state machine to block negotiation progression, route to the manual_review_trigger state, or terminate the negotiation sequence.

17. The system of claim 15, wherein generation of a weak_match decision state causes the negotiation control state machine to initiate with a restricted concession allowance range limiting the maximum concession generated during the concession_step state.

18. The system of claim 2, wherein the Explainability Artifact is consumed programmatically by the enforcement and routing layer to determine downstream system control actions, by audit systems to reconstruct decision provenance from the evidence_references field, by override analysis modules to evaluate proposed manual overrides, and by a negotiation control state machine to determine applicable negotiation constraint boundaries.

19. The system of claim 2, wherein the enforcement and routing layer prevents or pauses campaign budget allocation, negotiation initiation, offer generation, or contract generation when the bounded operational decision state is no_go or review_required, based on at least one of a campaign budget cap, a pricing threshold, a brand-safety rule, a confidence threshold, a validation failure indicator, or a contradiction indicator.

20. A computer-implemented method comprising:
receiving brand identity inputs from a brand operator through a structured questionnaire interface and producing a Brand Profile Vector encoding numerical representations of brand style attributes, emotional tone parameters, and campaign objectives;
presenting a consent interface to a creator operator prior to any processing of creator video content, recording a time-stamped digital consent record upon affirmative acceptance, and proceeding with processing only upon verification of a valid consent record;
processing creator video content through a computer vision module to extract a visual feature vector, through a voice and speech analysis module to extract an audio feature vector, and through a natural language processing module to extract a text feature vector;
combining the visual feature vector, audio feature vector, and text feature vector through a fusion component to produce a unified Creator Profile representation;
computing, by a compatibility scoring engine, a compatibility score quantifying the degree of alignment between the Brand Profile Vector and the unified Creator Profile representation;
computing a plurality of intermediate Signal Objects from bounded Evidence Objects including the compatibility score, wherein each Signal Object encodes a signal value, a confidence estimate, an uncertainty value, and dependency references; and
generating a bounded operational decision state selected from pass, weak_match, review_required, and no_go, based on the compatibility score and Constraint Objects, together with a Decision Object encoding the decision state, confidence score, uncertainty value, evidence references, reason codes, validation failure indicators, and trade-off indicators.

21. One or more non-transitory computer-readable storage media storing instructions that, when executed by one or more hardware processors, cause the processors to implement a creator-marketing decision architecture comprising:
a brand profiling module configured to receive brand identity inputs from a brand operator through a structured questionnaire interface and to produce a Brand Profile Vector encoding numerical representations of brand style attributes, emotional tone parameters, and campaign objectives;
a behavioral and affective video analysis sub-module configured to process creator video content through a computer vision module, a voice and speech analysis module, and a natural language processing module to extract feature vectors, and to combine those feature vectors through a fusion component to produce a unified Creator Profile representation;
a compatibility scoring engine configured to compute a compatibility score between the Brand Profile Vector and the unified Creator Profile representation;
a signal layer configured to receive bounded Evidence Objects including the compatibility score and to compute intermediate Signal Objects, wherein each Signal Object encodes a signal value, a confidence estimate, an uncertainty value, and dependency references; and
a decision engine configured to generate a bounded operational decision state selected from pass, weak_match, review_required, and no_go, based on intermediate Signal Objects and Constraint Objects derived from the compatibility score, together with a Decision Object encoding the decision state, confidence score, uncertainty value, evidence references, reason codes, validation failure indicators, and trade-off indicators.
